(19) United States
(12) Patent Application Publication
(10) Pub. No.: US 2022/0167187 A1
(43) Pub. Date: May 26, 2022

(54) UTILIZATION-AWARE MANAGEMENT OF DEVICE CAPABILITIES

(71) Applicant: AT&T Intellectual Property I, L.P., Atlanta, GA (US)

(72) Inventors: Yupeng Jia, Austin, TX (US); Yizhe Zhang, Austin, TX (US)

(21) Appl. No.: 17/100,270

(22) Filed: Nov. 20, 2020

(51) Int. Cl. H04W 24/08; H04W 24/02; H04L 12/26; H04L 12/24; H04W 48/02

(52) U.S. Cl. CPC H04W 24/08; H04W 24/02; H04L 43/0876; H04L 43/04; H04B 7/0413; H04L 43/16; H04L 41/16; H04W 48/02; H04L 43/065

(57) ABSTRACT

Device capabilities of a communication device can be managed in a utilization-aware manner A resource management component (RMC) can analyze usage data and historical usage data relating to usage of resources relating to frequency bands in carrier aggregation, MIMO, and RATs associated with the device in connection with power usage of the device. RMC can determine whether to adjust the resources associated with the device, based on a result of the analyzing, a threshold data throughput, and/or a state of the display screen of the device, to facilitate controlling an amount of power utilized by the device. If the threshold data throughput is satisfied, the RMC can remove a frequency band(s), reduce the number of MIMO layers, or fall back from a newer RAT to a legacy RAT. RMC can use artificial intelligence to determine a threshold for data throughput and a threshold for the display screen timer.

### TECHNICAL FIELD

This disclosure relates generally to electronic communications, e.g., to utilization-aware management of device capabilities.

### BACKGROUND

A communication device, such as a wireless or mobile communication device, can connect to a communication network to communicate with other communication devices and/or utilize applications. The communication device can utilize various applications under various circumstances. Different types of applications and communications can involve different data throughputs between the communication device and the communication network, and also can involve the use of different amounts of power, such as battery power, of the communication device. The communication device also can have a display screen. The communication device typically can utilize more power (e.g., battery power) when the display screen is in an on state as compared with when the display screen is in an off state.

The above-described description is merely intended to provide a contextual overview regarding electronic communications, and is not intended to be exhaustive.

### BRIEF DESCRIPTION OF THE DRAWINGS

FIG. 1 illustrates a block diagram of an example system that can desirably manage device capabilities, including resources of communication devices, in a utilization-aware manner, in accordance with various aspects and embodiments of the disclosed subject matter.

FIG. 2 depicts a block diagram of an example resource component comprising the various resources, functions relating to the various resources, and/or information relating to the various resources, in accordance with various aspects and embodiments of the disclosed subject matter.

FIG. 3 depicts a block diagram of a system that can utilize artificial intelligence or machine learning to desirably manage device capabilities, including resources of communication devices, in a utilization-aware manner, in accordance with various aspects and embodiments of the disclosed subject matter.

FIG. 4 presents a diagram of an example threshold adaptation process that can be employed to facilitate determining whether to adapt a threshold value, and/or determine an adaptation to make to a threshold value, to facilitate desirably managing device capabilities, including resources of communication devices, in a utilization-aware manner, in accordance with various aspects and embodiments of the disclosed subject matter.

FIG. 5 illustrates a block diagram of an example system that can desirably manage device capabilities, including respective resources of respective communication devices associated with one or more respective users, in a utilization-aware manner, in accordance with various aspects and embodiments of the disclosed subject matter.

FIG. 6 depicts a block diagram of an example resource management component 600 that can desirably manage device capabilities, including resources of communication devices, in a utilization-aware manner, in accordance with various aspects and embodiments of the disclosed subject matter.

FIG. 7 depicted is a block diagram of an example communication device operable to engage in a system architecture that facilitates wireless communications according to one or more embodiments described herein.

FIG. 8 illustrates a block diagram of an example access point, in accordance with various aspects and embodiments of the disclosed subject matter.

FIG. 9 illustrates a flow chart of an example method that can desirably manage device capabilities, including resources of communication devices, in a utilization-aware manner, in accordance with various aspects and embodiments of the disclosed subject matter.

FIG. 10 depicts a flow chart of another example method that can desirably manage device capabilities, including resources of communication devices, in a utilization-aware manner, in accordance with various aspects and embodiments of the disclosed subject matter.

FIG. 11 illustrates a flow chart of another example method that can perform an artificial intelligence or machine learning analysis to desirably determine or adapt a defined threshold data throughput to utilize for a communication device to facilitate managing device capabilities, including resources of the communication device, in a utilization-aware manner, in accordance with various aspects and embodiments of the disclosed subject matter.

FIG. 12 is a schematic block diagram illustrating a suitable computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

Discussed herein are various aspects and embodiments that relate to desirably managing resources associated with a communication device and, based at least in part on the managing of the resources, managing (e.g., controlling or reducing) power consumption associated with the communication device and/or an associated user. The disclosed subject matter can manage the group of resources of or associated with the communication device to facilitate desirably (e.g., improvedly, suitably, acceptably, or optimally) reducing or minimizing the amount of power consumed by the communication device, while also providing desirable (e.g., enhanced, suitable, acceptable, or optimal) use and quality of experience (QoE) of use of the communication device by the user (or another user(s)), such as more fully described herein.

The various aspects described herein can relate to new radio, which can be deployed as a standalone radio access technology or as a non-standalone radio access technology assisted by another radio access technology, such as Long Term Evolution (LTE), for example. It should be noted that although various aspects and embodiments have been described herein in the context of 5G, Universal Mobile Telecommunications System (UMTS), and/or Long Term Evolution (LTE), or other next generation networks, the disclosed aspects are not limited to 5G, a UMTS implementation, and/or an LTE implementation as the techniques can also be applied in 2G, 3G, 4G, or LTE systems. For example, aspects or features of the disclosed embodiments can be exploited in substantially any wireless communication technology. Such wireless communication technologies can include UMTS, Code Division Multiple Access (CDMA), Wi-Fi, Worldwide Interoperability for Microwave Access (WiMAX), General Packet Radio Service (GPRS), Enhanced GPRS, Third Generation Partnership Project (3GPP), LTE, Third Generation Partnership Project 2 (3GPP2) Ultra Mobile Broadband (UMB), High Speed Packet Access (HSPA), Evolved High Speed Packet Access (HSPA+), High-Speed Downlink Packet Access (HSDPA), High-Speed Uplink Packet Access (HSUPA), Zigbee, or another IEEE 802.XX technology. Additionally, substantially all aspects disclosed herein can be exploited in legacy telecommunication technologies. Further, the various aspects can be utilized with any Radio Access Technology (RAT) or multi-RAT system where the mobile device operates using multiple carriers (e.g., LTE Frequency Division Duplexing (FDD)/Time-Division Duplexing (TDD), Wideband Code Division Multiplexing Access (WCMDA)/HSPA, Global System for Mobile Communications (GSM)/GSM EDGE Radio Access Network (GERAN), Wi Fi, Wireless Local Area Network (WLAN), WiMax, CDMA2000, and so on).

As used herein, “5G” can also be referred to as New Radio (NR) access. Accordingly, systems, methods, and/or machine-readable storage media for reducing interference on reference signals from other co-channel reference signals, and improving the channel estimation performance for CSI estimation and data detection, in 5G systems, and other next generation systems, can be desired. As used herein, one or more aspects of a 5G network can comprise, but is not limited to, data rates of several tens of megabits per second (Mbps) supported for tens of thousands of users; at least one gigabit per second (Gbps) that can be offered simultaneously to tens of users (e.g., tens of workers on the same office floor); several hundreds of thousands of simultaneous connections supported for massive sensor deployments; spectral efficiency that can be significantly enhanced compared to 4G; improvement in coverage relative to 4G; signaling efficiency that can be enhanced compared to 4G; and/or latency that can be significantly reduced compared to LTE.

Multiple Input, Multiple Output (MIMO) technology can be employed in communication networks, wherein MIMO technology can be an advanced antenna technique utilized to improve spectral efficiency and, thereby, boost overall system capacity. Spectral efficiency (also referred to as spectrum efficiency or bandwidth efficiency) refers to an information rate that can be transmitted over a given bandwidth in a communication system.

For MIMO, a notation (M×N) can be utilized to represent the MIMO configuration in terms of a number of transmit antennas (M) and a number of receive antennas (N) on one end of the transmission system. Examples of MIMO configurations used for various technologies can include: (2×1), (1×2), (2×2), (4×2), (8×2) and (2×4), (4×4), (8×4). The configurations represented by (2×1) and (1×2) can be special cases of MIMO known as transmit and receive diversity.

In some cases, MIMO systems can significantly increase the data carrying capacity of wireless communications systems. Further, MIMO can be used for achieving diversity gain, which refers to an increase in signal-to-interference ratio due to a diversity scheme and, thus, can represent how much the transmission power can be reduced when the diversity scheme is introduced, without a corresponding performance loss. MIMO also can be used to achieve spatial multiplexing gain, which can be realized when a communications system is transmitting different streams of data from the same radio resource in separate spatial dimensions (e.g., data is sent/received over multiple channels, linked to different pilot frequencies, over multiple antennas). Spatial multiplexing gain can result in capacity gain without the need for additional power or bandwidth. In addition, MIMO can be utilized to realize beamforming gain. Due to the benefits achieved, MIMO can be an integral part of the third generation wireless system and the fourth generation wireless system. In addition, 5G systems also will employ massive MIMO systems (e.g., hundreds of antennas at the transmitter side and receiver side). Typically, with a (Nₜ, Nᵣ), where Nₜ denotes the number of transmit antennas and Nᵣ denotes the number of receive antennas, the peak data rate can multiple with a factor of Nₜ over single antenna systems in a rich scattering environment.

A communication device, such as a wireless or mobile communication device, can connect to a communication network to communicate with other communication devices and/or utilize applications. The communication device can utilize various applications under various circumstances. Different types of applications and communications can involve different data throughputs between the communication device and the communication network, and also can involve the use of different amounts of power, such as battery power, of the communication device. For instance, when the communication device is using an application that involves a higher data throughput, the communication device typically can utilize more power (e.g., battery power) than when the communication device is using another application that involves a relatively lower throughput.

The communication device also can have a display screen. The communication device typically can utilize more power (e.g., battery power) when the display screen is in an on state as compared with when the display screen is in an off state. Traditionally, some communication devices can employ a static display screen timer to turn off the display screen after the static display screen timer expires if there has be no activity or interaction with the display screen or another component of the communication device for the duration of the static display screen timer. A user can select a desired predefined static display screen timer from a set of available predefined static display screen timers (e.g., 10 second timer, 30 second timer, 1 minute timer, 2 minute timer, or another timer of a desired predefined amount of time). If desired, the user also can push a button or control on the communication device to immediately turn the display screen to the off state.

To that end, techniques for desirable utilization-aware management of device capabilities, including resources of a communication device, are presented. A resource management component (RMC) can analyze usage data and historical usage data relating to usage of resources relating to frequency bands in carrier aggregation, MIMO, and RATs associated with the device in connection with power usage of the device. The RMC can determine whether to adjust the resources associated with the device, based at least in part on a result of the analyzing, a defined threshold data throughput value, and/or a state of a display screen of the device, to facilitate controlling an amount of power utilized by the device. If the defined threshold data throughput value is determined to be satisfied (e.g., met or exceeded), the RMC can remove one or more frequency bands, can reduce the number or rank of MIMO layers, and/or can fall back from a newer RAT (e.g., 5G) to a legacy RAT (e.g., LTE).

The RMC can determine a defined threshold data throughput value to utilize with regard to a communication device, and/or can determine whether to adjust the defined threshold data throughput value, based at least in part on the results of analyzing the historical usage data. The RMC also can determine a defined threshold screen timer value to utilize with regard to a communication device, and/or can determine whether to adjust the defined threshold screen timer value, based at least in part on the results of analyzing the historical usage data associated with the communication device and/or user, wherein the defined threshold screen timer value can indicate an amount of time that is to elapse before turning the display screen from an on state to an off state if no activity with the display screen or other function of the communication device has been detected.

In some embodiments, the RMC can use artificial intelligence (AI) or machine learning to determine the defined threshold data throughput value to apply (e.g., with regard to an application or a user of the communication device) and/or the defined threshold screen timer value to apply with regard to switching the display screen from an on state to an off state. For example, the RMC can perform an AI or machine learning analysis on the historical usage data associated with the communication device and/or user to learn (e.g., self-learn) the defined threshold data throughput value and/or the defined threshold screen timer value to apply with regard to the communication device, application, and/or user. Based at least in part on the results of performing the AI or machine learning analysis on the historical usage data, the RMC can determine a defined threshold data throughput value and/or defined threshold screen timer value to apply with regard to the communication device, application, and/or user, and/or can determine whether to adjust a defined threshold data throughput value and/or defined threshold screen timer value with regard to the communication device, application, and/or user.

These and other aspects and embodiments of the disclosed subject matter will now be described with respect to the drawings.

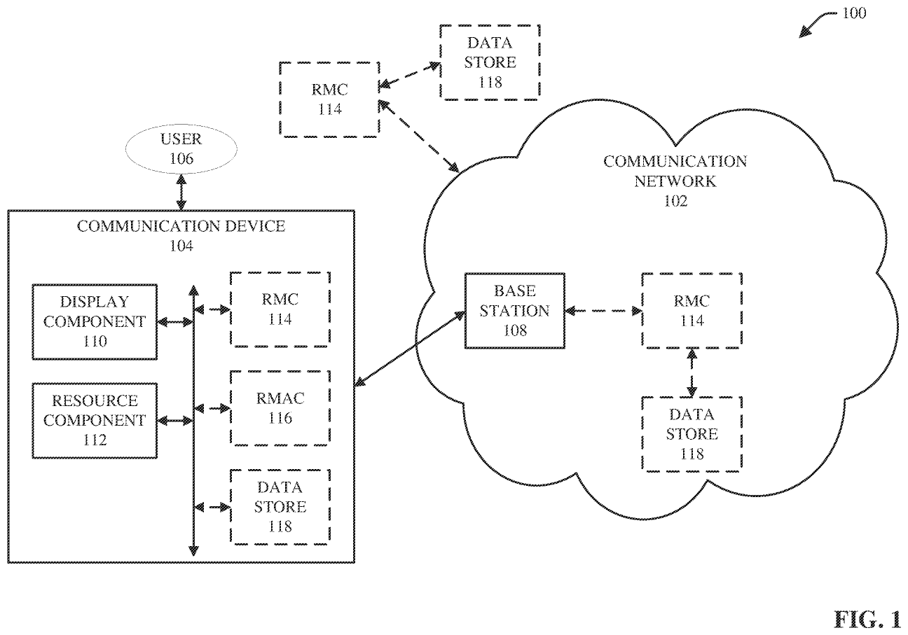

Referring now to the drawings, FIG. 1 illustrates a block diagram of an example system 100 that can desirably manage device capabilities, including resources of communication devices, in a utilization-aware manner, in accordance with various aspects and embodiments of the disclosed subject matter. The system 100 can include a communication network 102 that can comprise a mobility core network (e.g., a wireless communication network) and/or a packet data network (e.g., an IP-based network, such as the Internet and/or intranet) that can be associated with the mobility core network.

The mobility core network of the communication network 102 can operate to enable wireless communication between communication devices and/or between a communication device and the communication network 102. The communication network 102 can include various components, such as network (NW) nodes, e.g., radio network nodes) that can be part of the communication network 102 to facilitate communication of information between devices (e.g., communication devices) that can be associated with (e.g., communicatively connected to) the communication network 102. In some embodiments, the communication network 102 can employ MIMO technology to facilitate data communications between devices (e.g., network devices, communication devices, or other types of devices) associated with the communication network 102.

As used herein, the terms “network node,” “network node component,” and “network component” can be interchangeable with (or include) a network, a network controller, or any number of other network components. Further, as utilized herein, the non-limiting term radio network node, or network node can be used herein to refer to any type of network node serving communications devices and/or connected to other network nodes, network elements, or another network node from which the communications devices can receive a radio signal. In cellular radio access networks (e.g., universal mobile telecommunications system (UMTS) networks), network nodes can be referred to as base transceiver stations (BTS), radio base station, radio network nodes, base stations, NodeB, eNodeB (e.g., evolved NodeB), and so on. In 5G terminology, the network nodes can be referred to as gNodeB (e.g., gNB) devices. Network nodes also can include multiple antennas for performing various transmission operations (e.g., MIMO operations). A network node can comprise a cabinet and other protected enclosures, an antenna mast, and actual antennas. Network nodes can serve several cells, also called sectors, depending on the configuration and type of antenna. Network nodes can be, for example, Node B devices, base station (BS) devices, access point (AP) devices, TRPs, and radio access network (RAN) devices. Other examples of network nodes can include multi-standard radio (MSR) nodes, comprising: an MSR BS, a gNodeB, an eNodeB, a network controller, a radio network controller (RNC), a base station controller (BSC), a relay, a donor node controlling relay, a BTS, an AP, a transmission point, a transmission node, a Remote Radio Unit (RRU), a Remote Radio Head (RRH), nodes in distributed antenna system (DAS), and the like. In accordance with various embodiments, a network node can be, can include, or can be associated with (e.g., communicatively connected to) a network device of the communication network 102.

At given times, one or more communication devices, such as, for example, communication device 104, can connect or attempt to connect to the communication network 102 to communicate with the communication network 102 and/or communicate with other communication devices associated with the communication network 102. The communication device 104 can be associated with one or more users, such as user 106. A communication device (e.g., 104) also can be referred to as, for example, a device, a mobile device, or a mobile communication device. The term communication device can be interchangeable with (or include) a UE or other terminology. A communication device (or UE, device, . . . ) can refer to any type of wireless device that can communicate with a radio network node in a cellular or mobile communication system. Examples of communication devices can include, but are not limited to, a device to device (D2D) UE, a machine type UE or a UE capable of machine to machine (M2M) communication, a Personal Digital Assistant (PDA), a tablet or pad (e.g., an electronic tablet or pad), an electronic notebook, a mobile terminal, a cellular and/or smart phone, a computer (e.g., a laptop embedded equipment (LEE), a laptop mounted equipment (LME), or other type of computer), a smart meter (e.g., a smart utility meter), a target device, devices and/or sensors that can monitor or sense conditions (e.g., health-related devices or sensors, such as heart monitors, blood pressure monitors, blood sugar monitors, health emergency detection and/or notification devices, . . . ), a broadband communication device (e.g., a wireless, mobile, and/or residential broadband communication device, transceiver, gateway, and/or router), a dongle (e.g., a Universal Serial Bus (USB) dongle), an electronic gaming device, electronic eyeglasses, headwear, or bodywear (e.g., electronic or smart eyeglasses, headwear (e.g., augmented reality (AR) or virtual reality (VR) headset), or bodywear (e.g., electronic or smart watch) having wireless communication functionality), a music or media player, speakers (e.g., powered speakers having wireless communication functionality), an appliance (e.g., a toaster, a coffee maker, a refrigerator, or an oven, . . . , having wireless communication functionality), a set-top box, an IP television (IPTV), a device associated or integrated with a vehicle (e.g., automobile, airplane, bus, train, or ship, . . . ), a virtual assistant (VA) device, a drone, a home or building automation device (e.g., security device, climate control device, lighting control device, . . . ), an industrial or manufacturing related device, a farming or livestock ranch related device, and/or any other type of communication devices (e.g., other types of IoTs). It is to be appreciated and understood that, while the communication devices (e.g., 104), as described herein with regard to various embodiments, can be wireless communication devices that can connect to the communication network 102 via a wireless communication connection, in certain embodiments, a communication device can connect to the communication network 102 via a wireline communication connection, wherein such communication device can comprise functionality to utilize all or at least some of the various communication services that can be accessed via the communication network 102 (e.g., communication services that can be accessed via the SP network), such as described herein.

It is noted that the various aspects of the disclosed subject matter described herein can be applicable to single carrier as well as to multicarrier (MC) or carrier aggregation (CA) operation of the communication device. The term carrier aggregation (CA) also can be referred to (e.g., interchangeably called) “multi-carrier system,” “multi-cell operation,” “multi-carrier operation,” “multi-carrier” transmission and/or reception. In addition, the various aspects discussed can be applied for Multi RAB (radio access bearers) on some carriers (e.g., data plus speech can be simultaneously scheduled).

It is to be appreciated and understood that the terms element (e.g., element in connection with an antenna), elements, and antenna ports also can be used interchangeably, but can carry the same meaning, in this subject disclosure. In some embodiments, more than a single antenna element can be mapped to a single antenna port.

As disclosed, the mobility core network of the communication network 102 can include various network components or devices, which can include one or more base stations, such as, for example, base station 108. For instance, the mobility core network can include one or more radio access networks (RANs) (not explicitly shown in FIG. 1), wherein each RAN can include one or more base stations (e.g., access points (APs)), such as, for example base station 108. Each base station (e.g., base station 108) can serve communication devices (e.g., communication device 104) located in respective coverage areas served by respective base stations in the mobility core network of the communication network 102. The respective base stations can be associated with one or more sectors (not shown), wherein respective sectors can comprise respective cells. For instance, the base station 108 can comprise or be associated with one or more cells (not explicitly shown in FIG. 1). The cells can have respective coverage areas that can form the coverage area covered by the one or more sectors. The respective communication devices (e.g., communication device 104) can be communicatively connected to the communication network 102 via respective wireless or wireline communication connections with one or more of the respective cells.

In some embodiments, a RAN can be an open-RAN (O-RAN) that can employ an open interface that can support interoperability of devices (e.g., network devices) from different entities (e.g., vendors). The O-RAN can build or establish wireless connections through virtualization. In certain embodiments, the O-RAN can utilize a common platform that can reduce reliance on proprietary platforms of service providers. The O-RAN also can employ standardized interfaces and application programming interfaces (APIs) to facilitate open source implementation of the O-RAN. In certain embodiments, the RAN can be a cloud-RAN (C-RAN) that can be located in or associated with a cloud computing environment, which can include various cloud network components of the communication network 102.

It is to be appreciated and understood that, while various aspects and embodiments of the disclosed subject matter are described herein with regard to 5G and other next generation communication networks, the techniques of the disclosed subject matter described herein can be utilized (e.g., applied to), in same or similar form, to 4G communication networks, and the disclosed subject matter includes all such aspects and embodiments relating to implementation of the techniques of the disclosed subject matter to 4G communication networks.

With further regard to the communication device 104, the communication device 104 can comprise a display component 110, which can be or can comprise a display screen, such as, for example, a touch display screen. The display component 110 can have a desired size (e.g., desired length and desired width) and shape (e.g., rectangular, square, or circular).

The communication device 104 also can comprise a resource component 112 that can comprise various resources, functions relating to the various resources, and/or information relating to the various resources. The communication device 104 can utilize the various resources of or associated with the resource component 112 to facilitate communicating with the base station 108, communication network 102, and/or other communication devices associated with the communication network 102.

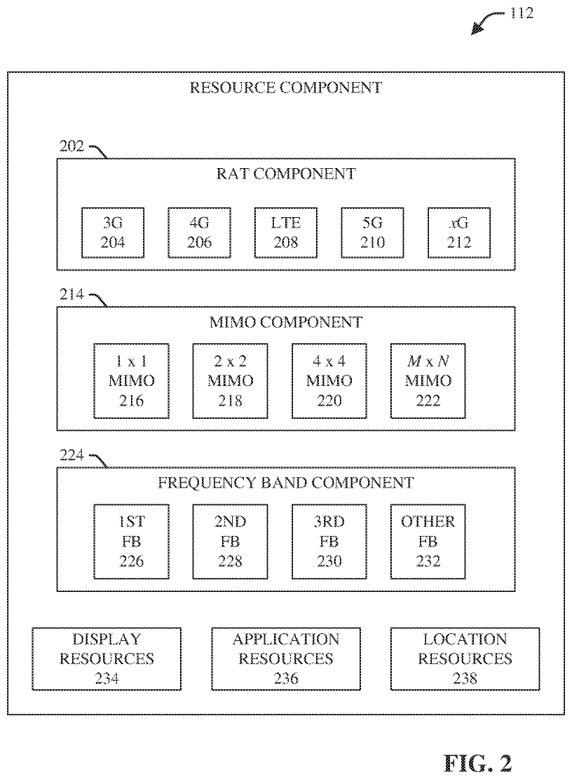

Referring to FIG. 2 (along with FIG. 1), FIG. 2 depicts a block diagram of an example resource component 112 comprising the various resources, functions relating to the various resources, and/or information relating to the various resources, in accordance with various aspects and embodiments of the disclosed subject matter. The resource component 112 can comprise a RAT component 202 that can comprise various RATs, functions relating to the various RATs, and/or information relating to the various RATs that can be employed by the communication device 104. The various RATs of the RAT component 202 can include, for example, 3G 204, 4G 206, 4G LTE 208, 5G 210, xG 212, or other desired RAT that currently exists or may exist in the future, as such RATs are described herein or known, wherein x can be virtually any desired integer value. In some embodiments, 4G LTE 208 can include 4G LTE-A (LTE advanced). In accordance with various embodiments, 5G 210 can be deployed as a standalone RAT or can be deployed as a non-standalone RAT that can be assisted by another RAT, such as, for example, 4G LTE 208. For instance, if and when 5G 210 is being deployed as a non-standalone RAT, 5G 210 can utilize the 4G LTE 208 as an anchor for the 5G 210 to carry signaling associated with the communication device 104. Thus, when 5G 210 is being deployed as a non-standalone RAT, 5G 210 and 4G LTE 208 can be utilized simultaneously or in tandem.

The resource component 112 also can comprise a MIMO component 214 that can comprise or facilitate utilization of various MIMO layers or ranks, functions relating to the various MIMO layers or ranks, and/or information relating to the various MIMO layers or ranks that can be employed by the communication device 104. For instance, the MIMO component 214 can comprise or facilitate utilization of 1×1 MIMO 216, 2×2 MIMO 218, 4×4 MIMO 220, or other M×N MIMO 222 (e.g., 2×1 MIMO, 1×2 MIMO, 4×2 MIMO, 8×2 MIMO, 2×4 MIMO, or 8×4 MIMO), wherein M and N can be virtually any desired integer values (e.g., 8 or other desired number), and wherein M and N can be the same as each other or different from each other. The number of MIMO layers employed at a given time, and the associated rank, can be based at least in part on the type of MIMO technology being employed. For example, when the communication device 104 is configured to be able to utilize 4×4 MIMO 220, the communication device 104 can comprise four transmitter antennas and four receiver antennas, and can transmit or receive up to four data streams or signals simultaneously. In the 4×4 MIMO 220 configuration, there can be up to four MIMO layers (e.g., one layer, two layers, three layers, or four layers) that can have a corresponding rank of one, two, three, or four, and can correspond to the transmitting or receiving of one, two, three, or four data streams or signals by the communication device 104.

The resource component 112 further can comprise a frequency band component 224 that can comprise or facilitate utilization of various frequency bands (e.g., in carrier aggregation), functions relating to the various frequency bands, and/or information relating to the frequency bands that can be employed by the communication device 104. The frequency band component 224 can comprise technology to or facilitate utilization of, for example, a first frequency band (1^{ST} FB) 226, second frequency band (2^{ND} FB) 228, third frequency band (3^{RD} FB) 230, and/or one or more other frequency bands (OTHER FB) 232. The respective frequency bands (e.g., 226, 228, 230, or 232) can be, for example, 700 megahertz (MHz), 850 MHz, 1700 MHz (e.g., 1700 MHz AWS-1 (AWS-1700/2100 MHz), 1700 MHz extended AWS (AWS-3-1700/2100 MHz)), 1900 MHz, 2300 MHz, or other desired frequency band. At various given times, the communication device 104 can utilize one or more frequency bands to facilitate communication of information (e.g., voice or data traffic), as more fully described herein.

In some embodiments, the resource component 112 can include display resources 234 that can comprise or facilitate utilization of various display-related resources associated with the display component 110. The display resources 234 can comprise the display screen and/or touch surface of the display screen of the display component 110, functions relating to switching (e.g., transitioning) the display component 110 between the on state (e.g., active state) or mode, off state (e.g., inactive state, sleep state) or mode, or other state (e.g., dim state, or reduced active state) or mode.

In certain embodiments, the resource component 112 can comprise application resources 236 that can comprise or facilitate utilization of various application-related resources associated with applications utilized by the communication device 104. The application resources 236 can comprise various functions relating to various applications, and/or various other information relating to the various applications that can be utilized by the communication device 104.

The resource component 112 also can include location resources 238 that can comprise or facilitate utilization of various location-related resources associated with the communication device 104 and/or applications that can be utilized by the communication device 104. The location resources 238 can comprise various functions relating to detecting or determining the location of the communication device 104 and/or utilizing the location of the communication device 104 in connection with one or more applications associated with the communication device 104, and/or can comprise various other information relating to location-related features associated with the communication device 104.

To facilitate desirably managing resources associated with the communication device 104, the system 100 can comprise a resource management component (RMC) 114 and a data store 118 (e.g., a data store comprising a database(s)) that can be associated with (e.g., communicatively connected to) the RMC 114. In accordance with various embodiments, the RMC 114 and/or the data store 118 can reside in the communication device 104, can reside in the communication network 102, can be external to (e.g., in a cloud computing environment or platform) and associated with (e.g., communicatively connected to) the communication network 102, and/or can comprise sub-components or functions that can be distributed among the communication network 102, the communication device 104, or as part of another device, as desired. In some embodiments, if the RMC 114 does not reside in the communication device 104, the system 100 can comprise a remote management agent component (RMAC) 116 that can be associated with (e.g., communicatively connected to) the RMC 114 on a regular basis, periodic basis, or aperiodic basis (e.g., dynamic basis), wherein the RMAC 116 can communicate information (e.g., usage data, queries, status of the communication device 104 or application, or other desired information) to the RMC 114, and the RMC 114 can communication information (e.g., threshold values, modification information or instructions relating to modification of resources, other types of instructions, or other desired information) to the RMAC 116.

The RMC 114 can manage (e.g., control) the group of resources (e.g., RATs and RAT functions, frequency bands, MIMO layers or rank, battery or other power resources, or other resources) of or associated with the communication device 104 to facilitate reducing or minimizing the amount of power consumed by the communication device, while also providing desirable (e.g., enhanced, suitable, acceptable, or optimal) use and quality of experience (QoE) of use of the communication device 104 by the user (or another user(s)), in accordance with defined resource management criteria. To facilitate managing the group of resources, the RMC 114 and/or RMAC 116 can monitor and track operation of the communication device 104, including monitoring and tracking usage of the communication device 104 by a user (e.g., interaction or activity of the user with the communication device 104 or other usage of the communication device 104 by the user), resources of or associated with the communication device 104, applications used by the communication device 104, or other usage of the communication device 104. Based at least in part on the monitoring and tracking, the RMC 114 can receive, obtain, or collect usage data relating to the operation and usage of the communication device 104 by the user. The RMC 114 can be associated with (e.g., communicatively connected to) or can comprise a data store 118. The RMC 114 can store usage data associated with communication devices, including the communication device 104, in the data store 118. For instance, the RMC 114 can store and maintain historical usage data associated with communication devices (e.g., communication device 104) in the data store 118 and as new (e.g., current) usage data associated with communication devices is received by the RMC 114, the RMC 114 can store the newly received usage data in the data store 118.

In some embodiments, the RMC 114 (and/or an AI component of or associated therewith) can analyze the historical usage data (and/or any new usage data as it is received) associated with the communication device 104 and/or associated user (e.g., user 106 or another user). Based at least in part on the results of such analysis of the historical usage data (and/or any new usage data), the RMC 114 can determine respective defined threshold data throughput values, respective defined screen timer values, respective defined threshold timer values associated with determining whether to adapt (e.g., reduce) resources (e.g., when a determination of whether to modify or reduce resources can be performed without regard to the display screen state), or other respective threshold values that can be applicable with regard to respective power information, respective applications, respective types of applications, respective application statuses, respective types of activities, respective users, respective contexts, and/or other respective factors associated with the communication device 104 and/or the associated user (e.g., user 106 or another user). The RMC 114 can store the respective defined threshold data throughput values, the respective defined screen timer values, the respective defined threshold timer values associated with determining whether to adapt resources, and/or the other respective threshold values in the data store 118. The RMC 114 or RMAC 116 can enable the use of a desired (e.g., appropriate, suitable, acceptable, or optimal) defined threshold data throughput value, defined screen timer value, defined threshold timer value associated with determining whether to adapt resources, or other threshold value by the communication device 104 at a given time, in accordance with the defined resource management criteria, as more fully described herein.

In certain embodiments, when the communication device 104 is initialized (e.g., turned on), enters the area of and/or attempts to connect to the communication network 102, and/or sends a query to request a threshold value(s) to the RMC 114, the RMC 114 can determine a set of threshold values that are to be utilized by the communication device 104 based at least in part on the results of analyzing the historical usage data associated with the communication device 104 and/or the user 106, and/or any current usage data associated with the communication device 104 that is available to the RMC 114. For instance, in response to the communication device 104 being initialized, entering the area of and/or attempting to connect to the communication network 102, and/or the sending of the query, the communication network 102 (e.g., a network device of the communication network 102) can determine initial power information associated with the communication device 104, and can communicate the initial power information to the RMC 114 and/or the communication device 104. The RMC 114 can receive the power information associated with the communication device 104 from the communication network 102.

The RMC 114 can analyze the power information, other currently available information (e.g., currently available usage data, such as type of application being used) associated with the communication device 104 and/or the user 106, and/or the historical usage data, which can comprise the respective defined threshold data throughput values, the respective defined screen timer values (e.g., as previously determined by the RMC 114), and/or the respective defined threshold timer values associated with determining whether to adapt (e.g., reduce) resources. Based at least in part on the results of such analysis, the RMC 114 can determine a set of threshold values that are to be used (e.g., at least initially used) by the communication device 104 during the communication session. The set of threshold values can comprise one or more respective defined threshold data throughput values that can be associated with (e.g., related to or applicable to) respective applications, respective types of applications, respective application statuses, respective types of activities, respective users, and/or other respective factors. The set of threshold values also can comprise one or more respective defined screen timer values that can be associated with (e.g., related to or applicable to) respective applications, respective types of applications, respective application statuses, respective types of activities, respective users, and/or other respective factors. In certain embodiments, the set of threshold values can include one or more respective defined threshold timer values, which can indicate if and when a determination is to be performed regarding whether to adapt (e.g., reduce) resources, wherein the one or more respective defined threshold timer values can be associated with (e.g., related to or applicable to) respective applications, respective types of applications, respective application statuses, respective types of activities, respective users, and/or other respective factors. A defined threshold timer value, which can indicate if and when a determination is to be performed regarding whether to adapt (e.g., reduce) resources, can be employed, for example, when a determination of whether to modify or reduce resources can be performed without regard to the display screen state of the display screen of the communication device 104. For instance, the RMC 114 can determine whether to modify (e.g., reduce) resources of the set of resources, whether the display screen is in an on state or an off state, when the amount of time the user has not interacted with an application (e.g., open application), or has not used the application for a particular activity (e.g., video streaming of video content that uses a significant amount of resources), satisfies (e.g., meets or exceeds, or breaches) the defined threshold timer value associated with determining whether to adapt resources.

In some embodiments, in connection with preparing to provide (e.g., send) or utilize, or in temporal proximity to providing or utilizing, the set of threshold values to or for the communication device 104, the RMC 114 can retrieve the set of threshold values from the data store 118 (e.g., as such set of threshold values was previously determined based at least in part on the historical usage data stored in the data store 118 and stored in the data store 118). In other embodiments, in connection with preparing to provide or utilize, or in temporal proximity to providing or utilizing, the set of threshold values to or for the communication device 104, the RMC 114 can determine the set of threshold values based at least in part on the results of an analysis (e.g., a new or current analysis) of the historical usage data.

In accordance with various embodiments, the RMC 114 can provide the set of threshold values to the RMAC 116 of the communication device 104 (e.g., when the RMC 114 does not reside in the communication device 104) for use or implementation by the RMAC 116, or can use or implement the set of threshold values for the communication device 104 (e.g., when the RMC 114 resides within the communication device 104). The RMC 114 or RMAC 116 can use or implement a desired (e.g., appropriate, suitable, or optimal) defined threshold data throughput value(s), desired defined screen timer value(s), and/or desired defined threshold timer value(s) associated with determining whether to adapt resources of the set of threshold values during operation of the communication device 104 to facilitate reducing consumption of power (e.g., battery power) by the communication device 104.

In some embodiments, during operation of the communication device 104, the RMC 114 or RMAC 116 can analyze usage data (e.g., current usage data) and/or historical usage data relating to usage of the group of resources associated with the communication device 104 and/or associated user (e.g., user 106 or another user), in connection with power usage (e.g., usage of battery power) of the communication device 104, wherein the group of resources can relate to RATs (e.g., 3G, 4G, LTE, 5G, xG, or other type of RAT), frequency bands in carrier aggregation, multipath propagation (e.g., MIMO layers or rank), and/or other resources, as more fully described herein. Based at least in part on the result of the analysis of the usage data and/or the historical usage data, and a defined threshold data throughput value (e.g., the application of the defined threshold data throughput value), the RMC 114 or RMAC 116 can determine whether to modify (e.g., adjust, change, reduce, or remove) one or more resources of the group of resources associated with the communication device 104, to facilitate controlling (e.g., reducing) an amount of power utilized by the communication device 104, as more fully described herein. The defined threshold data throughput value can relate to, for example, an amount of data throughput being used, or expected (e.g., predicted or projected) to be used, by the communication device 104 and/or application being utilized or expected to be utilized by the communication device 104.

In some embodiments, the RMC 114 or RMAC 116 can perform such analysis and determine whether to modify the group of resources, in response to determining that the display screen of the display component 110 is in an off state, wherein the state of the display screen can be controlled based at least in part on the applicable defined screen timer value. In other embodiments, the RMC 114 or RMAC 116 can perform such analysis and determine whether to modify the group of resources without regard to whether the display screen of the display component 110 is in an off state or an on state. With further regard to the state of the display screen of the communication device 104, the RMC 114 can manage (e.g., control, adjust, modify, or change) a defined threshold screen timer value (e.g., defined threshold time or defined threshold amount of time) associated with the communication device 104, as more fully described herein. The defined threshold screen timer value can be utilized (e.g., applied) to indicate when the display screen of the display component 110 of the communication device 104 is to be transitioned from an on or active state to an off or inactive state, for example, in response to no activity or interaction with the display screen, or a button or function associated with the display screen, being detected by the communication device 104 (e.g., RMAC 116 or other component of the communication device 104) for an amount of time that satisfies (e.g., meets or exceeds, or breaches) the defined threshold screen timer value.

In accordance with various embodiments, the RMC 114 can employ AI or machine learning techniques, functions, or algorithms to facilitate determining whether to modify (e.g., adapt) defined threshold data throughput values, defined threshold screen timer values, resources of the group of resources, or other features (e.g., functions or characteristics) associated with communication devices (e.g., communication device 104) to facilitate desirably (e.g., improvedly, suitably, acceptably, or optimally) reducing the amount of power consumed by communication devices, while maintaining desirable (e.g., enhanced, suitable, acceptable, or optimal) operation of the communication devices, in accordance with the defined resource management criteria, as more fully described herein.

With further regard to the management of the group of resources and determining whether to modify the group of resources, in some embodiments, the RMC 114 and/or RMAC 116 can monitor and track the usage, activity, and application usage and status associated with the communication device 104, including monitoring whether one or more applications are being utilized by the communication device 104, what type of application(s), if any, is being used by the communication device 104, the type of data being communicated to or from the communication device 104, the data throughput, if any, associated with the application(s) being used by the communication device 104, the amount of data being communicated (e.g., received or transmitted) in connection with the communication device 104, the display screen status of the display component 110 of the communication device 104, the user (e.g., user 106 or other user) who is using the communication device 104, and/or other contexts, aspects, or characteristics (e.g., communication device usage-related characteristics) associated with the communication device 104 and/or the user 106 (or other user) utilizing the communication device 104. The type of application can relate to, for example, the name or identifier of an application, what type of activity or function the application performs (e.g., video streaming, audio streaming, provide textual information, social media application, messaging application, phone call application, map application, exercise application, or health monitoring application), or other desired characteristic of the application.

In some embodiments, the RMC 114 or RMAC 116 can determine whether to perform an analysis and determination relating to whether to modify the group of resources based at least in part on a status (e.g., display screen status) of the display screen of the display component 110 of the communication device 104. The RMC 114 or RMAC 116 can determine the status (e.g., on or active state, off or sleep state, or other state) of the display screen of the display component 110 of the communication device 104 based at least in part on the monitoring and tracking of the usage and activity associated with the communication device 104. In these embodiments, if the RMC 114 or RMAC 116 determines that the display screen is in the on state, the RMC 114 or RMAC 116 can determine that the group of resources is not to be modified, or can determine that no analysis and determination relating to determining whether to modify the group of resources associated with the communication device 104 has to be performed. The RMC 114 or RMAC 116 can continue to monitor the status of the display screen of the communication device 104 to determine the status of the display screen. If, instead, the RMC 114 or RMAC 116 determines that the display screen is in the off state, the RMC 114 or RMAC 116 can determine whether to modify the group of resources associated with the communication device 104, in accordance with the defined resource management criteria, as more fully described herein.

In other embodiments, the RMC 114 or RMAC 116 can determine whether to perform an analysis and determination relating to whether to modify the group of resources associated with the communication device 104 without regard to the status of the display screen of the display component 110 of the communication device 104. In such embodiments, the RMC 114 or RMAC 116 can determine whether to modify the group of resources whether the display screen is in the on state or the off state (or another display screen state). For instance, the RMC 114 or RMAC 116 can determine that an analysis and determination relating to whether to modify the group of resources associated with the communication device 104 is to be performed on a regular or periodic basis, dynamically (e.g., in response to a change in context, a change from one application to another application, a change of user of the communication device 104, or another type of change associated with the communication device 104), or based on an applicable defined threshold timer value associated with determining whether to adapt resources being satisfied (e.g., met or exceeded, or breached), such as more fully described herein.

If the RMC 114 or RMAC 116 determines that an analysis and determination relating to determining whether to modify the group of resources associated with the communication device 104 is to be performed, the RMC 114 or RMAC 116 can determine whether to modify the group of resources associated with the communication device 104 based at least in part on the results of analyzing the data throughput associated with the communication device 104 and the applicable defined threshold data throughput value. The RMC 114 or RMAC 116 can determine the defined threshold data throughput value (e.g., from the set of threshold values) that is applicable to the communication device 104 at a given time based at least in part on the application being used by the communication device 104, the type of application, the application status, the type of activity (e.g., video streaming, video call, audio streaming, text messaging, social media, or other activity) being engaged in using the communication device 104, the user (e.g., user 106 or other user) who is using the communication device 104, the context associated with the communication device 104 or associated user (e.g., user 106 or other user), or another desired factor, in accordance with the defined resource management criteria.

The RMC 114 or RMAC 116 can determine the data throughput that can be desired (e.g., requested, utilized, wanted, demanded, or needed) by the communication device 104 and/or the application being utilized by the communication device 104, based at least in part on the application or application type, the application status, the type of activity being engaged in using the communication device 104 or application, or another desired factor. The RMC 114 or RMAC 116 can analyze (e.g., compare) the data throughput and the applicable defined threshold data throughput value. The RMC 114 or RMAC 116 can determine whether the data throughput associated with the communication device 104 satisfies (e.g., meets, breaches, or exceeds) the defined threshold data throughput value based at least in part on the results of analyzing the data throughput associated with the communication device 104 and the defined threshold data throughput value associated with (e.g., applicable to) the communication device 104.

If, based at least in part on the results of analyzing (e.g., comparing) the data throughput and the defined threshold data throughput value, the RMC 114 or RMAC 116 determines that the data throughput associated with the communication device 104 satisfies (e.g., meets, breaches, exceeds, and/or is greater than) the defined threshold data throughput value, the RMC 114 or RMAC 116 can determine that the group of resources associated with the communication device 104 is not be modified at that time. In response to determining that the group of resources is not be modified at that time, the RMC 114 or RMAC 116 can continue to monitor and track the usage and activity of the communication device 104.

If, instead, based at least in part on the results of analyzing (e.g., comparing) the data throughput and the defined threshold data throughput value, the RMC 114 or RMAC 116 determines that the data throughput associated with the communication device 104 does not satisfy (e.g., is less or lower than, and/or does not meet or exceed) the defined threshold data throughput value, the RMC 114 or RMAC 116 can determine that one or more resources of the group of resources can be modified. For instance, when the data throughput associated with the communication device 104 does not satisfy the defined threshold data throughput value, the RMC 114 or RMAC 116 can determine that the communication device 104 does not have to have all of the resources of the group of resources currently being utilized by the communication device 104 to achieve or attain the desired (e.g., enhanced, suitable, acceptable, or optimal) use and/or QoE of use of the communication device 104 for the user 106, and that the group of resources can be modified (e.g., reduced) to save (e.g., reduce) power of the communication device 104, while still maintaining desirable use and/or QoE of use of the communication device 104 or application for the user 106. Accordingly, the RMC 114 or RMAC 116 can determine that the group of resources associated with the communication device 104 can be modified.

In some embodiments, in response to determining that one or more resources of the group of resources can be modified, the RMC 114 or RMAC 116 can modify or facilitate modifying the operation of the communication device 104 to suspend using a first RAT (e.g., 5G 210) and to use, or continue to use, a second RAT (e.g., LTE 208), as more fully described herein. For example, the RMC 114 or RMAC 116 can modify or facilitate modifying the operation of the communication device 104 to release the use of 5G 210 (e.g., non-standalone 5G 210) and to continue the use of LTE 208 (e.g., to fallback to LTE 208) by the communication device 104. Modifying the resources to have the communication device 104 fall back from using (e.g., to suspend the use of) the first RAT (e.g., 5G 210) to using, or maintaining the usage of, the second RAT (e.g., LTE 208) can desirably reduce the amount of power consumed by the communication device 104.

In certain embodiments, in addition to or as an alternative to modifying the RAT used by the communication device 104, in response to determining that one or more resources of the group of resources can be modified, the RMC 114 or RMAC 116 can modify the group of resources associated with the communication device 104 to remove one or more frequency bands of the group of frequency bands in carrier aggregation associated with the communication device 104, as more fully described herein. For example, with regard to the frequency band component 224, the RMC 114 or RMAC 116 can modify the group of resources to remove one or more frequency bands (e.g., remove the first frequency band 226, second frequency band 228, third frequency band 230, and/or one or more other frequency bands 232) that were being used by the communication device 104. Modifying the group of resources to remove one or more frequency bands associated with the communication device 104 can desirably reduce the amount of power consumed by the communication device 104.

In some embodiments, in addition to or as an alternative to modifying the RAT used by the communication device 104 and/or removing one or more frequency bands associated with the communication device 104, in response to determining that one or more resources of the group of resources can be modified, the RMC 114 or RMAC 116 can modify the group of resources associated with the communication device 104 to remove one or more MIMO layers associated with the communication device 104. For example, with regard to the MIMO component 214, the RMC 114 or RMAC 116 can modify the group of resources to remove one or more MIMO layers (e.g., with regard to 1×1 MIMO 216, 2×2 MIMO 218, 4×4 MIMO 220, or other M×N MIMO 222), or correspondingly can modify or reduce the MIMO rank, being used by the communication device 104. Modifying the resources to remove one or more MIMO layers associated with the communication device 104 can desirably reduce the amount of power consumed by the communication device 104.

The disclosed subject matter, by employing the RMC 114, RMAC 116, artificial intelligence or machine learning, and the techniques, methods, and algorithms described herein, can desirably (e.g., improvedly, suitably, or optimally) manage or reduce the use of resources of the group of resources of the communication device 104, and can thereby desirably (e.g., improvedly, suitably, or optimally) manage, reduce, or minimize consumption of power by communication devices associated with users, while also achieving, attaining, providing, or maintaining desired (e.g., enhanced, suitable, acceptable, or optimal) use and/or QoE of use of the communication device 104 for the user 106 (or another user). These and other features of the disclosed subject matter (e.g., the RMC 114, RMAC 116, artificial intelligence or machine learning, and the techniques, methods, and algorithms described herein) can thereby provide enhanced operation of communication devices and enhanced preservation of or reduction in use of power (e.g., battery power) by communication devices, as compared to traditional methods for managing power consumption by communication devices.

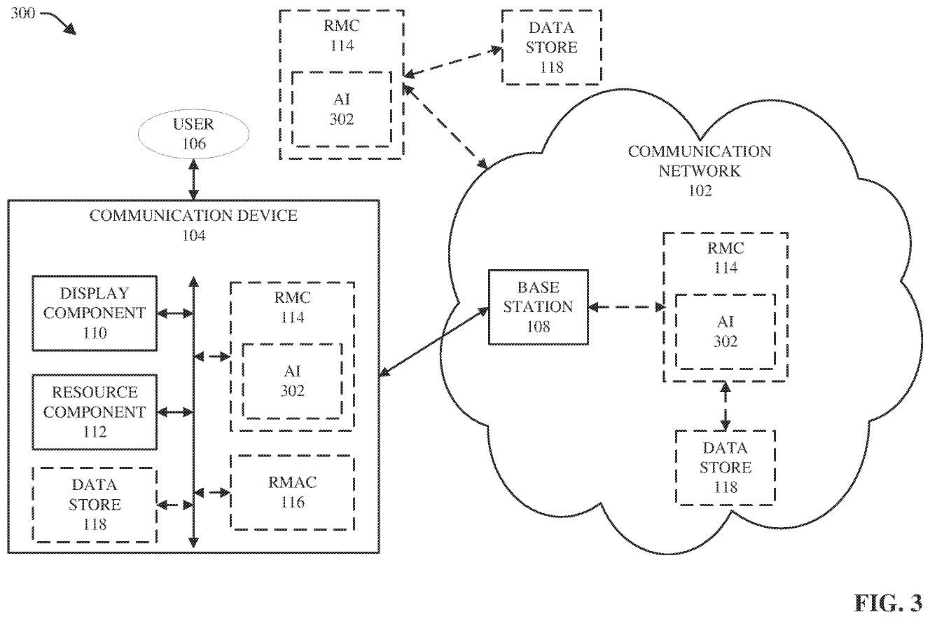

Turning to FIG. 3, FIG. 3 depicts a block diagram of a system 300 that can utilize AI or machine learning to desirably manage device capabilities, including resources of communication devices, in a utilization-aware manner, in accordance with various aspects and embodiments of the disclosed subject matter. The system 300 can comprise the communication network 102, communication device 104, and base station 108, as more fully described herein. A user 106 can be associated with (e.g., can be using or interacting with) the communication device 104. The communication device 104 can comprise the display component 110 and resource component 112, as more fully described herein. In accordance with various embodiments, the system 300 also can comprise RMC 114, RMAC 116, and/or data store 118, wherein the RMC 114 can reside in the communication device 104, the communication network 102, or outside of the communication device 104 and communication network 102, as more fully described herein.

In accordance with various embodiments, the RMC 114 can comprise or be associated with an AI component (AI) 302 that can perform AI or machine learning analysis on data, including usage data, historical usage data, application-related data (e.g., data relating to application characteristics, including functions and features of applications), demographic data, communication device-related data (e.g., data relating to device characteristics, including functionality, technological capabilities, or other features of communication devices), and/or other data, associated with users and/or communication devices, using desired AI or machine learning techniques, algorithms, or functions. Based at least in part on the results of such AI or machine learning analysis, the AI component 302 can determine, learn (e.g., learn and refine over time), or identify respective sets of threshold values, respective threshold value adaptations, respective resource adaptations, respective parameters, or other desired respective information associated with, and for use with (e.g., for application to), respective communication devices (e.g., communication device 104 or other communication devices) and/or users (e.g., user 106 or other users), in accordance with the defined resource management criteria.

For instance, based at least in part on the results of an AI or machine learning analysis, the AI component 302 can determine, learn (e.g., learn and refine over time), or identify a usage pattern or usage characteristics of or associated with a user 106 and/or associated communication device(s) 104. Based at least in part on the usage pattern or the usage characteristics associated with the user 106 and/or communication device(s) 104, and/or other results of such AI or machine learning analysis, the AI component 302 can determine, learn, or identify a set of threshold values (e.g., defined threshold data throughput value, defined screen timer value, defined threshold time associated with determining whether to adjust resources, or other desired threshold value), threshold value adaptations (e.g., modifications to threshold values), resource adaptations (e.g., modifications to resources of the group of resources), parameters, or other desired information associated with the communication device(s) 104 and/or user 106 that can be used (e.g., applied) to facilitate desirably reducing consumption of power (e.g., battery power) by the communication device 104, while also still providing desirable usage of the communication device 104 or application by the user 106 and/or desirable QoE of the user 106 when using the communication device 104 or application, in accordance with the defined resource management criteria.

For example, if the user 106 often uses the communication device 104 to stream video content using one or more particular applications and/or at particular times (e.g., particular time(s) of day, particular day(s) of the week), based at least in part on the results of an AI or machine learning analysis of usage data, historical usage data, or other data associated with the user 106 and relating to such activity, the AI component 302 can determine, learn, or identify a pattern of usage by the user 106 that can indicate that the user 106 often uses the communication device 104 to stream video content using the one or more particular applications and/or at the particular times. As another example, if the user 106 uses the communication device 104 relatively little or uses it for relatively low-data uses (e.g., sending text messages) while at certain types of events or places (e.g., sporting events, concerts, or work place), based at least in part on the results of an AI or machine learning analysis of usage data, historical usage data, or other data associated with the user 106 and relating to such activity, the AI component 302 can determine, learn, or identify a pattern of usage by the user 106 that can indicate that the user 106 uses the communication device 104 relatively little or uses it for the relatively low-data uses while at the certain types of events or places.

The AI component 302 can use these usage patterns and other usage patterns of the user 106 that it can determine from performing AI or machine learning analysis of usage data, historical usage data, or other data associated with the user 106 to determine one or more defined threshold data throughput values to apply when the user 106 is using the communication device 104 to facilitate controlling the group of resources and, accordingly, control power consumption of the communication device 104. For instance, the AI component 302 can determine, infer, or predict that a first (e.g., relatively higher) threshold data throughput value can be desirable (e.g., useful, beneficial, suitable, or optimal) when the user 106, using the communication device 104, is using the one or more particular applications during the particular times, and a second (e.g., relatively lower) threshold data throughput value can be desirable when the user, using the communication device 104, is using an application (e.g., texting application) that is associated with relatively low-data use while the user 106 and communication device 104 are at a certain type of event or place (e.g., sporting event, concert, or work place).

As still another example, with regard to threshold timer values (e.g., defined threshold screen timer value, or defined threshold timer value associated with determining whether to adapt or adjust resources), if the user 106 uses a particular application that typically can involve viewing content on the touch display screen of the communication device 104 with relatively little physical interaction (e.g., touching buttons on the touch display screen), and/or the user 106 frequently periodically touches the touch display screen (e.g., just prior to the display screen transitioning to the off state) to keep the display screen from transitioning from an on state to an off state, based at least in part on the results of an AI or machine learning analysis of usage data, historical usage data, or other data associated with the user 106 and relating to such activity, the AI component 302 can determine, learn, or identify a pattern of usage by the user 106 that can indicate that, when using that particular application to view content, the user 106 can desire to have the touch display screen remain in an on state for an extended period of time before or without transitioning to an off state. Accordingly, the AI component 302 can determine, infer, or predict that a relatively longer threshold screen timer value can be desirable (e.g., useful, beneficial, suitable, or optimal) when the user 106, using the communication device 104, is using that particular application so that the touch display screen can remain in the on state for a relatively longer amount of time without physical interaction with the touch display screen by the user 106 before transitioning to the off state.

As yet another example, if the user 106 often uses a particular music streaming application that typically can involve the user 106 listening to audio content on the communication device 104 (e.g., while walking, jogging, or working out) with relatively little physical interaction (e.g., touching buttons on the touch display screen) after the user 106 has selected a song or set of songs (e.g., song playlist), based at least in part on the results of an AI or machine learning analysis of usage data, historical usage data, or other data associated with the user 106 and relating to such activity, the AI component 302 can determine, learn, or identify a pattern of usage by the user 106 that can indicate that, when using that particular music streaming application to listen to streaming audio content (and/or when movement of the device 104 or an open workout application indicates that the user is walking, jogging, or working out), the user 106 is not likely to physically interact with the touch display screen while listening to the song(s) and/or is not likely to be using the touch display screen to view any content on the display screen, and/or the user 106 can desire to have the touch display screen transition to an off state relatively quickly after selection of the song or set of songs by the user 106. Accordingly, the AI component 302 can determine, infer, or predict that a relatively short threshold screen timer value can be desirable (e.g., useful, beneficial, suitable, or optimal) when the user 106, using the communication device 104, is using that particular music streaming application (and/or the workout application) so that the touch display screen can transition from an on state to an off state in a relatively short amount of time after the user has last touched a button on the touch display screen of the communication device 104 (e.g., to select a song or set of songs).

In still another example, the AI component 302 can determine, learn, or infer a threshold value to use based at least in part on a usage pattern of the user 106 with regard to using battery power to power the communication device 104 and using alternating current (AC) or external power to power or charge the communication device 104. For instance, if the user 106 frequently connects the communication device 104 to an external power source to charge the battery or use the communication device 104 at particular times (e.g., when the user 106 arrives at home after work, when the user 106 is at work, at night when the user 106 is going to bed, or when the user 106 is in the car), based at least in part on the results of an AI or machine learning analysis of usage data, historical usage data, or other data associated with the user 106 and relating to such activity, the AI component 302 can determine, learn, or identify a pattern of usage by the user 106 that can indicate those particular times when the user 106 frequently connects the communication device 104 to an external power source to charge the battery or use the communication device 104. Based at least in part on such usage pattern, the AI component 302 can determine, learn, or infer a threshold value(s) (e.g., defined threshold data throughput value or defined threshold screen timer value) to use for the communication device 104 in relation to (e.g., in temporal proximity to) those particular times and/or with regard to battery power levels of the communication device 104. For example, if the user 106 is using an application (e.g., video streaming application) that can use a significant amount of resources of the communication device 104, and if a relatively low battery level of the communication device 104 would otherwise indicate that a defined threshold data throughput value should be relatively lower or a defined threshold screen timer value should be relatively shorter, but, based at least in part on the usage pattern, the AI component 302 determines, infers, or predicts that the communication device 104 will soon (e.g., at one of those particular times) be connected to external power to charge the battery or use the communication device 104, the AI component 302 can determine or infer that it can be desirable (e.g., suitable or acceptable) to use a relatively higher threshold data throughput value that can be suitable for applications associated with higher data throughputs and/or can determine or infer that it can be desirable to use a relatively longer screen timer value to maintain the touch display screen of the device 104 in an on state for a relatively longer period of time before transitioning to an off state due to lack of interaction with the touch display screen, since it can be predicted that the device 104 will be connected to external power relatively soon.

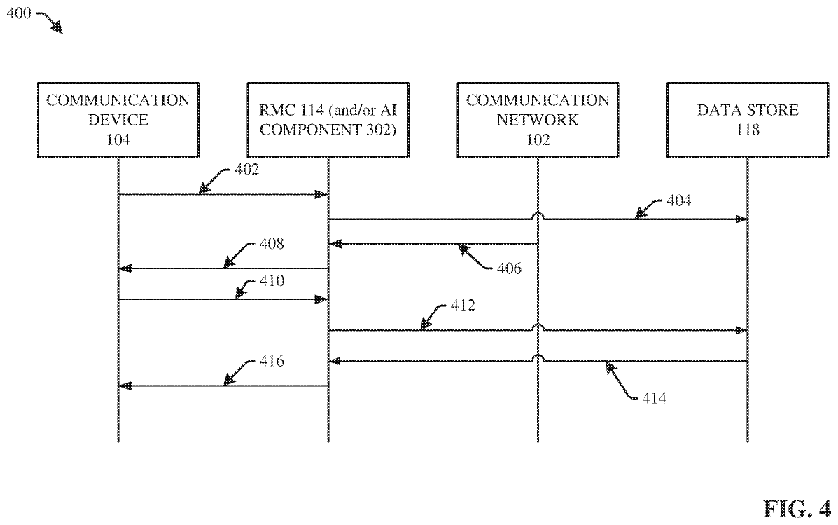

Referring to FIG. 4 (along with FIG. 3), FIG. 4 presents a diagram of an example threshold adaptation process 400 that can be employed to facilitate determining whether to adapt a threshold value, and/or determine an adaptation to make to a threshold value, to facilitate desirably managing device capabilities, including resources of communication devices, in a utilization-aware manner, in accordance with various aspects and embodiments of the disclosed subject matter.

In accordance with the example threshold adaptation process 400, at reference numeral 402, the communication device 104 can communicate a query for threshold to the RMC 114 to request a set of threshold values (e.g., defined threshold data throughput value, defined screen timer value, or defined threshold timer value) from the RMC 114. This can be done, for example, in response to use or initialization of the communication device 104 and/or connection of the communication device 104 to the communication network 102. In some embodiments, the RMC 114 also can receive or obtain current usage data (e.g., application being used, type of content being communicated, or other usage data) relating to usage of the communication device 104 from the communication device 104, the communication network 102, or another source.

At reference numeral 404 of the example threshold adaptation process 400, the RMC 114 can obtain historical usage data associated with the communication device 104 and/or user 106 from the data store 118. For instance, in response to receiving the query from the communication device 104, the RMC can retrieve the historical usage data from the data store 118.

At reference numeral 406 of the example threshold adaptation process 400, the RMC 114 can receive initial power information associated with the communication device 104 from the communication network 102. For instance, in response to use or initialization of the communication device 104 and/or connection of the communication device 104 to the communication network 102, the communication network 102 can determine the initial power information associated with the communication device 104 and can communicate the initial power information to the RMC 114 and/or communication device 104. The RMC 114 or the AI component 302 can determine or infer a set of threshold values based at least in part on the results of analyzing (e.g., results of performing an AI or machine learning analysis on) the current usage data, the historical usage data, the initial power information, and/or other available and pertinent information associated with the communication device 104 and/or user 106, as more fully described herein.

At reference numeral 408 of the example threshold adaptation process 400, the RMC 114 can communicate the set of threshold values and/or the initial power information to the communication device 104. The RMC 114 (if part of the communication device) or the RMAC 116 can utilize or implement the set of threshold values and/or the initial power information during operation of the communication device 104, as more fully described herein.

At reference numeral 410 of the example threshold adaptation process 400, the RMC 114 can continue to receive usage data and application status data from the communication device 104. The RMC 114 can monitor or track the operation of the communication device, and can continue to obtain usage data and application status data from the communication device 104 to update the usage data and application status data available to the RMC 114. In accordance with various embodiments, the communication device 104 can provide or can otherwise make available (e.g., via monitoring and tracking by the RMC 114) the usage data and application status data to the RMC 114 on a continuous, substantially continuous, periodic, or dynamic basis, as desired.

At reference numeral 412 of the example threshold adaptation process 400, the RMC 114 can store the updated usage data and application status data in the data store 118. For instance, as the RMC 114 obtains the updated usage data and application status data from the monitoring or tracking of the operation of the communication device 104, the RMC 114 can update the data store 118 to store the updated usage data and application status data in the data store 118.

At reference numeral 414 of the example threshold adaptation process 400, the RMC 114 and/or AI component 302 can retrieve, from the data store 118, the updated historical usage data, including one or more updates to such data from the storing of updated usage data and application status data in the data store 118. The RMC 114 and/or AI component 302 can analyze (e.g., can perform an AI or machine learning analysis on) the updated historical usage data and/or other pertinent data (e.g., demographic information) associated with the communication device 104 and/or user 106. Based at least in part on the results of such analysis, the RMC 114 and/or AI component 302 can determine or infer one or more updated threshold values that can be used for the communication device 104 in place of one or more current threshold values; or, if the current set of threshold values are determined to be desirable (e.g., suitable, acceptable, or optimal), the RMC 114 and/or AI component 302 can determine that no adjustments are to be made to the current set of threshold values.

At reference numeral 416 of the example threshold adaptation process 400, if the RMC 114 determines that one or more threshold values of the current set of threshold values are to be adjusted to one or more updated threshold values, the RMC 114 can provide or implement the one or more updated threshold values to or in the communication device 104. The RMC 114 or RMAC 116 can utilize (e.g., apply) the one or more updated threshold values, and any remaining (e.g., non-updated) threshold values (if any) of the set of threshold values, to determine whether to make a determination regarding whether to modify resources of the group of resources, determine whether to modify resources of the set of resources, determine whether to transition the display screen of the communication device 104 from an on state to an off state, and/or to perform other operations associated with the communication device 104, as more fully described herein. The RMC 114, AI component 302, and/or other components of the system 300 can continue to perform the various operations, updates to usage data or application statuses, and/or updates to threshold values on a continuous, substantially continuous, periodic, or dynamic basis, as desired.

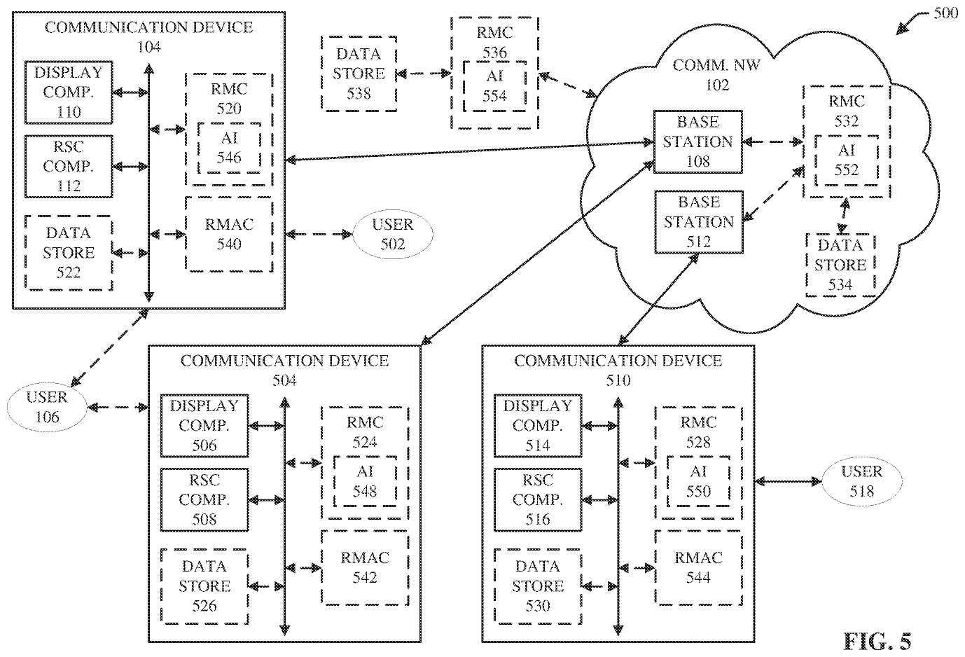

FIG. 5 illustrates a block diagram of an example system 500 that can desirably manage device capabilities, including respective resources of respective communication devices associated with one or more respective users, in a utilization-aware manner, in accordance with various aspects and embodiments of the disclosed subject matter. The system 500 can comprise the communication network (COMM. NW) 102, communication device 104, and base station 108, as more fully described herein. A user 106 can be associated with (e.g., at various given times, can be using or interacting with) the communication device 104. At certain times, a user 502 can utilize the communication device 104 as well. The communication device 104 can comprise the display component (DISPLAY COMP.) 110 and resource component (RSC COMP.) 112, as more fully described herein.

The system 500 also can comprise a communication device 504 that can be associated with the communication network 102 via the base station 108 (or another base station of the communication network 102). The communication device 504 can include a display component 506 and a resource component 508. At various given times, the user 106 (or another user) can use the communication device 504.

The system 500 further can comprise a communication device 510 that can be associated with the communication network 102 via the base station 512 (or another base station of the communication network 102). The communication device 504 can include a display component 514 and a resource component 516. At various given times, a user 518 (or another user) can use the communication device 510.

In accordance with various embodiments, the system 500 also can comprise one or more RMCs, one or more RMACs, and/or one or more associated data stores, wherein an RMC and/or associated data store can reside in a communication device, can reside in the communication network 102, or can reside outside of the communication device and communication network 102, as more fully described herein. In some embodiments, the communication device 104 can comprise RMC 520 and data store 522, which can be associated with (e.g., communicatively connected to) the RMC 520, the communication device 504 can comprise RMC 524 and data store 526, which can be associated with the RMC 524, and/or the communication device 510 can comprise RMC 528 and data store 530, which can be associated with the RMC 528.

In other embodiments, the system 500 can comprise RMC 532 and associated data store 534 that can reside in the communication network 102. In still other embodiments, the system 500 can comprise RMC 536 and associated data store 538 that can reside outside of the communication devices and communication network 102, but can be associated with (e.g., communicatively connected to) the communication network 102 and communication devices (e.g., communication devices 104, 504, and/or 510), for example, via the communication network 102. If the RMC is located outside of the communication devices, the communication devices (e.g., communication devices 104, 504, and/or 510) can respectively comprise an RMAC 540, RMAC 542, and/or RMAC 544.

An RMC also can comprise or be associated with an AI component. For instance, in accordance with various embodiments, RMC 520 can comprise or be associated with AI component 546, RMC 524 can comprise or be associated with AI component 548, RMC 528 can comprise or be associated with AI component 550, RMC 532 can comprise or be associated with AI component 552, and/or RMC 536 can comprise or be associated with AI component 554.

The respective devices or components of the system 500 can be the same as or similar to, or can comprise the same or similar functionality as, other respective devices or components (e.g., respectively named devices or components), such as more fully described herein.

An RMC (e.g., 520, 524, 528, 532, or 536) of or associated with a communication device (e.g., 104, 504, or 510) can determine whether to adapt (e.g., adjust, modify, or change) one or more types of resources (e.g., RATs, frequency bands, MIMO layers, or other type of resource) associated with the communication device, and, if so, can determine adaptations that can be made to the one or more types of resources associated with the communication device, based at least in part on the results of analyzing usage data (e.g., current usage data), historical usage data, application status of an application being used, current resource usage, a current or applicable defined threshold data throughput value, a status (e.g., off or inactive state, on or active state, or other state) of a display screen, and/or AI or machine learning analysis results associated with the communication device or associated user, as more fully described herein. An RMC (e.g., 520, 524, 528, 532, or 536) of or associated with a communication device (e.g., 104, 504, or 510) also can determine whether to adapt a threshold value, such as a defined threshold data throughput value, a defined screen timer value, a defined threshold timer value associated with determining whether to adapt resources, or other desired threshold value associated with a communication device or associated user, and, if so, can determine the adaptation (e.g., the amount of adaptation) to be made to the threshold value, based at least in part on the results of analyzing usage data, historical usage data, application status of an application being used, current resource usage, a current or applicable threshold value, and/or AI or machine learning analysis results associated with the communication device or associated user, as more fully described herein. In some embodiments, an RMC (e.g., 520, 524, 528, 532, or 536) can employ an associated AI component (e.g., 546, 548, 550, 552, or 554) to perform an AI or machine learning analysis on data (e.g., usage data, historical usage data, or other data) to facilitate determining whether to adapt resources, the amount of adaptation (if any) of resources, whether to adapt a threshold value, and/or the amount of adaptation (if any) of a threshold value, as more fully described herein.

In some embodiments, an RMC (e.g., 520, 532, or 536) of or associated with a communication device (e.g., 104) associated with a user (e.g., 106) can propagate a set of threshold values, threshold value adaptations, resource adaptations, or other desired information associated with the communication device (e.g., 104) to another communication device (e.g., 504) associated with the user (e.g., 106). For example, the RMC (e.g., 520, 532, or 536) of or associated with the communication device 104 can know (e.g. be made aware of) or determine that the user 106 uses the communication device 104 and communication device 504 at various times. Based at least in part on determining that the user 106 utilizes both the communication device 104 and communication device 504, the RMC (e.g., 520, 532, or 536) of or associated with the communication device 104 can propagate a set of threshold values, threshold value adaptations, resource adaptations, or other desired information, or a portion thereof (e.g., portion of the set of threshold values, threshold value adaptations, or resource adaptations), associated with the communication device 104 to the other communication device 504 associated with the user 106, and vice versa (e.g., RMC of or associated with communication device 504 can propagate threshold values, threshold value adaptations, resource adaptations, or other desired information associated with communication device 504 and user 106 to the communication device 104).

When the user 106 is using the communication device 504, the RMC (e.g., 524, 532, or 536) or RMAC 542 of or associated with the communication device 504 can utilize all or a desired portion of the set of threshold values, the threshold value adaptations, the resource adaptations, or the other desired information that was propagated for use with the communication device 504, as determined to be appropriate, in accordance with the defined resource management criteria. In some embodiments, the RMC (e.g., 524, 532, or 536) or RMAC 542 of or associated with the communication device 504 can take into account any differences in the type, functionality, or power consumption of the communication device 504 relative to (e.g., as compared to) the type, functionality, or power consumption of the communication device 104 and/or any differences in a usage pattern relating to use of the communication device 504 relative to another usage pattern relating to the use of the communication device by the user 106 when determining which of the propagated threshold values, threshold adaptations, resource adaptations, or other information to use with the communication device 504.

For example, if the usage pattern relating to use of the communication device 104 by the user 106 indicates that the user 106 interacts with the display screen of the display component 110 of the communication device 104 in a significantly different way than the user 106 interacts with the display screen of the display component 506 of the communication device 504 such that the defined threshold screen timer value associated with the communication device 104 is determined (e.g., by the RMC) to not be desirable (e.g., determined to not be suitable, acceptable, appropriate, or optimal) for use with the communication device 104, the RMC (e.g., 520, 524, 532, or 536) can determine that the defined threshold screen timer value is not to be propagated to or used by the communication device 504.

As another example, if the communication device 104 is 5G-capable, but the communication device 504 is not 5G-capable and can operate using LTE 208 RAT technology, the RMC (e.g., 520, 524, 532, or 536) (or the RMAC 542) can determine that any resource adaptations, threshold values, or threshold adaptations relating to transitioning from 5G 210 to LTE 208 can be disregarded (e.g., can not be propagated to the communication device 504) with regard to managing resources and power consumption associated with the communication device 504.

In certain embodiments, an RMC (e.g., 520, 532, or 536) or RMAC (e.g., 540) of or associated with a communication device (e.g., 104) associated with a first user (e.g., 106) can determine and/or use a first set of threshold values, first threshold value adaptations, first resource adaptations, or other first parameters associated with the first user when the first user is determined to be using the communication device. When a second user (e.g., 502) is determined to be using the communication device (e.g., 104), the RMC (e.g., 520, 532, or 536) or RMAC (e.g., 540) can determine and/or use a second set of threshold values, second threshold value adaptations, second resource adaptations, or other second parameters associated with the second user. That is, the RMC (e.g., 520, 532, or 536) or RMAC (e.g., 540) can maintain respective sets of threshold values, respective threshold value adaptations, respective resource adaptations, or other respective parameters for use with respective users.

For instance, when using the communication device 104, the first user 106 may have a first usage pattern that can be different from a second usage pattern of the second user 502 when the second user 502 is using the communication device 104 with regard to the types of applications that are used by the respective users, the respective activity or interaction of the users with regard to applications (e.g., second user 502 is more likely to stream video content than the first user 106 is; the second user 502 is more likely to interact, or more frequently interacts, with the display screen than the first user 106; or the second user 502 uses or is more likely to use certain social media sites or applications that are not used or are less likely to be used by the first user 106), or other usage factors. Based at least in part on analysis of the respective usage data and respective historical usage data of the respective users 106 and 502, the RMC (e.g., 520, 532, or 536) can determine or identify the first usage pattern of the first user 106 and the second user pattern of the second user 502 and the differences between the first usage pattern and the second usage pattern. Accordingly, based at least in part on such analysis results, the RMC (e.g., 520, 532, or 536) can determine the first set of threshold values, first threshold value adaptations, first resource adaptations, or other first parameters associated with the first user 106, and can determine the second set of threshold values, second threshold value adaptations, second resource adaptations, or other second parameters associated with the second user 502. The RMC (e.g., 520, 532, or 536) or RMAC 540 can apply the first set of threshold values, first threshold value adaptations, first resource adaptations, or other first parameters when the first user 106 is determined to be using the communication device 104, and can apply the second set of threshold values, second threshold value adaptations, second resource adaptations, or other second parameters when the second user 502 is determined to be using the communication device 104.

To facilitate determining which user is using a communication device (e.g., 104) at a given time and which set of threshold values, threshold value adaptations, resource adaptations, or other parameters to use for the communication device at a given time, the RMC (e.g., 520, 532, or 536) or RMAC (e.g., 540) can determine or detect when respective users (e.g., user 106, user 502) are using the communication device (e.g., 104) based at least in part on a change (e.g., an identifiable change) in usage pattern in use of the communication device, respective biometric information (e.g., fingerprint information, eye or iris scanning information, facial recognition information, or other biometric information) associated with the respective users, or other desired factors. For example, the RMC (e.g., 520, 532, or 536) or RMAC (e.g., 540) can detect when there is a change in usage pattern in use of the communication device from a usage pattern (e.g., first usage pattern) that is consistent with the first user 106 to a usage pattern (e.g., second usage pattern) that is consistent with the second user 502. Additionally or alternatively, the RMC (e.g., 520, 532, or 536) or RMAC (e.g., 540) can detect and recognize biometric information (e.g., fingerprint or facial features) associated with the second user 502 that can indicate that the first user 106 is not currently using the communication device and the second user 502 is now using the communication device. Accordingly, the RMC (e.g., 520, 532, or 536) or RMAC (e.g., 540) can determine that the first user 106 is no longer using the communication device and the second user 502 is now currently using the communication device, and can modify operation to apply the second set of threshold values, second threshold value adaptations, second resource adaptations, or other second parameters associated with the second user 502.

In some embodiments, an RMC (e.g., 520, 532, or 536) of or associated with a first communication device (e.g., 104) associated with a first user (e.g., 106) can propagate a set of threshold values, threshold value adaptations, resource adaptations, parameters, or other desired information, or a portion thereof (e.g., portion of the set of threshold values, threshold value adaptations, or resource adaptations), associated with the first communication device (e.g., 104) and the first user to a second communication device (e.g., 510) associated with a second user (e.g., 518), for use by the second communication device with regard to the second user, when doing so is in accordance with the defined resource management criteria. For instance, an RMC (e.g., 520, 532, or 536) can determine first usage characteristics (e.g., first usage pattern) relating to usage of the communication device 104, applications, services, or other functions or features associated with the communication device 104, based at least in part on the results of analyzing first usage data and first historical usage data associated with the communication device 104 and/or the first user 106. In some embodiments, the RMC (e.g., 520, 532, or 536) can access first demographic information relating to (e.g., indicative of or applicable to) the first user 106 from a desired data source (e.g., a device of a service provider associated with the communication device 104, or a device of a third-party provider that can provide demographic information), and can analyze the first demographic information to determine first demographic characteristics of the first user 106.

An RMC (e.g., 528, 532, or 536) of or associated with a second communication device, such as communication device 510, can determine second usage characteristics (e.g., second usage pattern) relating to usage of the communication device 510, applications, services, or other functions or features associated with the communication device 510, based at least in part on the results of analyzing second usage data and second historical usage data associated with the communication device 510 and/or second user 518. In some embodiments, the RMC (e.g., 528, 532, or 536) can access second demographic information relating to (e.g., indicative of or applicable to) the second user 518 from a desired data source (e.g., a device of a service provider associated with the communication device 510, or a device of the third-party provider), and can analyze the second demographic information to determine second demographic characteristics of the second user 518.

The RMC (e.g., 520, 528, 532, or 536) can analyze the first usage characteristics and/or first demographic information associated with the first user 106 and the second usage characteristics and/or second demographic information associated with the second user 518. Based at least in part on the results of such analysis, the RMC (e.g., 520, 528, 532, or 536) can determine whether there are sufficient similarities between the first usage characteristics and/or first demographic information associated with the first user 106 and the second usage characteristics and/or second demographic information associated with the second user 518 such that propagation of all or a portion of the set of threshold values, threshold value adaptations, resource adaptations, parameters, or other desired information associated with the first communication device 104 and/or first user 106 can be desirable (e.g., suitable, acceptable, appropriate, or optimal), in accordance with the defined resource management criteria. If the RMC (e.g., 520, 528, 532, or 536) determines that there are sufficient similarities between the first usage characteristics and/or first demographic information and the second usage characteristics and/or second demographic information, the RMC can determine that propagation of all or a portion of the set of threshold values, threshold value adaptations, resource adaptations, parameters, or other desired information associated with the first communication device 104 and/or first user 106 to the second communication device 510 and/or second user 518 can be desirable and can be performed. If, instead, the RMC (e.g., 520, 528, 532, or 536) determines that there are not sufficient similarities between the first usage characteristics and/or first demographic information and the second usage characteristics and/or second demographic information, the RMC can determine that propagation of the set of threshold values, threshold value adaptations, resource adaptations, parameters, or other desired information associated with the first communication device 104 and/or first user 106 to the second communication device 510 and/or second user 518 is not desirable and not to be performed.

In some embodiments, the RMC (e.g., 520, 528, 532, or 536) can take into account the respective locations of respective users in determining whether to propagate a set of threshold values, threshold value adaptations, resource adaptations, or other desired information, or a portion thereof (e.g., portion of the set of threshold values, threshold value adaptations, or resource adaptations), associated with the first communication device 104 and the first user 106 to the second communication device 510 associated with the second user 518, for use by the second communication device 510 with regard to the second user 518, when in accordance with the defined resource management criteria. For example, when the first communication device 104 and first user 106 and the second communication device 510 and second user 518 are located in proximity to each other (e.g., they are located at the same event), the RMC (e.g., 520, 528, 532, or 536) can receive respective location information from the respective communication devices 104 and 510, and based at least in part on the results of the analysis of the respective location information, the RMC can determine that the respective communication devices 104 and 510 are within a defined distance of each other and/or are located at the same event or place (e.g., sporting event, concert, show, casino, nightclub, or other event or place). In response to determining that the first communication device 104 and first user 106 and the second communication device 510 and second user 518 are located in such proximity to each other, and, if, based at least in part on the results of analyzing the first usage characteristics and/or first demographic information associated with the first user 106 and the second usage characteristics and/or second demographic information associated with the second user 518, the RMC determines that there are sufficient similarities between the first usage characteristics and/or first demographic information and the second usage characteristics and/or second demographic information, the RMC can determine that propagation of all or a portion of the set of threshold values, threshold value adaptations, resource adaptations, parameters, or other desired information associated with the first communication device 104 and/or first user 106 to the second communication device 510 and/or second user 518 can be desirable and can be performed, in accordance with the defined resource management criteria.

In certain embodiments, if, instead, the RMC (e.g., 520, 528, 532, or 536) determines that the first communication device 104 and first user 106 and the second communication device 510 and second user 518 are not located in proximity to each other (e.g., they are not located at the same event or place), the RMC may determine that an analysis of the respective usage characteristics and/or respective demographic information does not have to be performed to determine whether to propagate the set of threshold values, threshold value adaptations, resource adaptations, parameters, or other desired information associated with the first communication device 104 and/or first user 106 to the second communication device 510 and/or second user 518, and/or can determine that propagation of the set of threshold values, threshold value adaptations, resource adaptations, parameters, or other desired information associated with the first communication device 104 and/or first user 106 to the second communication device 510 and/or second user 518 is not to be performed.

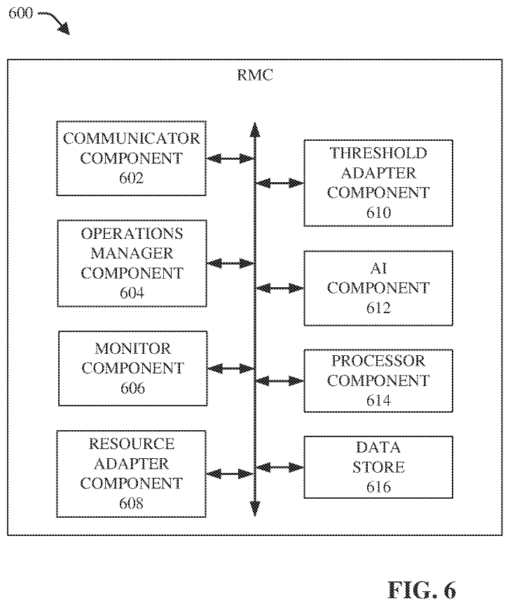

FIG. 6 depicts a block diagram of an example RMC 600 that can desirably manage device capabilities, including resources of communication devices, in a utilization-aware manner, in accordance with various aspects and embodiments of the disclosed subject matter. The RMC 600 can comprise a communicator component 602, an operations manager component 604, a monitor component 606, a resource adapter component 608, a threshold adapter component 610, an AI component 612, a processor component 614, and/or a data store 616.

The communicator component 602 can communicate (e.g., transmit and receive) information, including information relating to usage data associated with one or more users, historical usage data associated with one or more users, resources associated with one or more communication devices, applications associated with one or more communication devices, power information associated with one or more communication devices, threshold values, or instructions or commands. For instance, the communicator component 602 can receive usage data associated with a communication device and/or associated user from the communication device, a network device of the communication network, or an application-related device associated with an application. The communicator component 602 also can receive power information or other information associated with the communication device from a network device of the communication network. The communicator component 602 also can transmit threshold values (e.g., defined threshold data throughput value, defined threshold screen timer value, or defined threshold timer value associated with determining whether to adapt resources), updates (e.g., adjustments or adaptations) to threshold values, and/or other desired information to the communication device.

The operations manager component 604 can control (e.g., manage) operations associated with the RMC 600. For example, the operations manager component 604 can facilitate generating instructions to have components of the RMC 600 perform operations, and can communicate respective instructions to respective components (e.g., communicator component 602, monitor component 606, resource adapter component 608, threshold adapter component 610, AI component 612, processor component 614, and/or data store 616) of the RMC 600 to facilitate performance of operations by the respective components of the RMC 600 based at least in part on the instructions, in accordance with the defined resource management criteria and resource management algorithms (e.g., resource management algorithms, AI or machine learning algorithms, or other type of algorithm, as disclosed, defined, recited, or indicated herein by the methods, systems, and techniques described herein). The operations manager component 604 also can facilitate controlling data flow between the respective components of the RMC 600 and controlling data flow between the RMC 600 and another component(s) or device(s) (e.g., communication devices, network devices of the communication network, applications, data sources, services, or other component or device) associated with (e.g., connected to) the RMC 600.

The monitor component 606 can monitor or track respective usage, activity, and application usage and status associated with one or more respective communication devices and/or one or more respective users, including monitoring whether one or more applications are being utilized by a communication device, what type of application(s), if any, is being used by the communication device, the type of data being communicated to or from the communication device, the data throughput, if any, associated with the application(s) being used by the communication device, the amount of data being communicated between (e.g., received or transmitted by) the communication device and another device (e.g., network device, application-related device, another communication device, or other type of device), a display screen status of the communication device, a user who is using the communication device, location-related information relating to the location of the communication device, and/or other contexts, aspects, or characteristics (e.g., communication device usage-related characteristics) associated with the communication device and/or the user who is utilizing the communication device. The monitor component 606 can obtain or capture, or facilitate obtaining or capturing, such information from or in connection with various other components or devices of or associated with the one or more communication devices.

The resource adapter component 608 can determine whether to adapt (e.g., adjust, modify, or change) one or more types of resources (e.g., RATs, frequency bands, MIMO layers, or other type of resource) associated with a communication device, and, if so, can determine adaptations that can be made to the one or more types of resources associated with the communication device, based at least in part on the results of analyzing usage data (e.g., current usage data), historical usage data, application status of an application being used, current resource usage, a current or applicable defined threshold data throughput value, a status of a display screen, and/or AI or machine learning analysis results associated with the communication device or associated user, as more fully described herein. For example, based at least in part on the results of analyzing a current data throughput (e.g., desired, wanted, demanded, or needed data throughput) associated with the communication device and an applicable defined threshold data throughput value, the resource adapter component 608 can determine whether to adapt one or more types of resources of or associated with the communication device. If, based at least in part on the results of analyzing the current data throughput and the applicable defined threshold data throughput value, the resource adapter component 608 determines that one or more types of resources are to be adapted (e.g., due to the current data throughput being less than the applicable defined threshold data throughput value), the resource adapter component 608 can determine the adaptation that is to be made to the one or more types of resources and can generate or facilitate generating instructions to adapt the one or more types of resources associated with the communication device, in accordance with the determined resource adaptation.

In some embodiments, the resource adapter component 608 can perform such analysis and make such determination regarding whether to adapt the one or more resources, in response to determining or detecting that the display screen of the communication device is in an off or inactive state. In other embodiments, the resource adapter component 608 can perform such analysis and make such determination regarding whether to adapt the one or more resources without regard to the state of the display screen of the communication device.

The threshold adapter component 610 can determine whether to adapt (e.g., adjust, modify, or change) a threshold value, such as a defined threshold data throughput value, a defined screen timer value, a defined threshold timer value associated with determining whether to adapt resources, or other desired threshold value associated with a communication device or associated user, and, if so, can determine the adaptation (e.g., the amount of adaptation) to be made to the threshold value, based at least in part on the results of analyzing usage data, historical usage data, application status of an application being used, current resource usage, a current or applicable threshold value, and/or AI or machine learning analysis results associated with the communication device or associated user, as more fully described herein. For example, based at least in part on the results of an AI or machine learning analysis performed (e.g., by the AI component 612) on usage data and/or historical usage data associated with the communication device and/or associated user, the threshold adapter component 610 can determine whether to adapt a defined threshold data throughout value associated with the communication device or associated user, and, if so, can determine the amount of adaptation that is to be made to the defined threshold data throughout value. For instance, if the AI or machine learning analysis results (e.g., derived from self-learning by the AI component 612) indicate that increasing (or decreasing) the defined threshold data throughout value to an updated defined threshold data throughout value can improve savings (e.g., can enhance reduction) in consumption of power by the communication device, while still providing desirable usage (e.g., usability) of the communication device or application by the user and/or desirable QoE of the user when using the communication device or application, the threshold adapter component 610 can determine that the defined threshold data throughout value is to be increased (or decreased) to the updated defined threshold data throughout value.

The AI component 612 can utilize AI or machine learning techniques, algorithms, or functions to facilitate performing an AI or machine learning analysis on usage data, historical usage data, or other information associated with one or more communication devices and associated users to facilitate determining whether to adapt a threshold value (e.g., a defined threshold data throughput value, a defined screen timer value, or other desired threshold value) associated with a communication device or associated user, and, if so, the amount of adaptation of the threshold value, and/or facilitate determining whether to adapt one or more types of resources associated with the communication device or associated user, and, if so, the amount of adaptation of the one or more types of resources, as more fully described herein. For instance, the AI component 612, employing a desired AI or machine learning technique(s), algorithm(s), or function(s), can perform an AI or machine learning analysis on usage data and historical usage data associated with a communication device(s) and associated user(s) with respect to a threshold value (e.g., defined threshold data throughput value, defined screen timer value, or other desired threshold value). Based at least in part on the results of the AI or machine learning analysis, the AI component 612 can determine, infer, or predict that adjusting the threshold value to an updated threshold value can result in a desirable reduction in consumption of power (e.g., battery power) by the communication device, while still providing desirable usage of the communication device or application by the user and/or desirable QoE of the user when using the communication device or application. The AI component 612 can communicate the AI or machine learning analysis results, which can include the updated threshold value, and/or the determination, inference, or prediction regarding adjusting the threshold value to the updated threshold value, to the threshold adapter component 610 for consideration, analysis, or action by the threshold adapter component 610, such as more fully described herein.

The processor component 614 can work in conjunction with the other components (e.g., communicator component 602, operations manager component 604, monitor component 606, resource adapter component 608, threshold adapter component 610, AI component 612, and/or data store 616) to facilitate performing the various functions of the RMC 600. The processor component 614 can employ one or more processors, microprocessors, or controllers that can process data, such as information relating to communication devices, users, subscriber-related information, usage data, historical usage data, location data (e.g., data regarding locations of communication devices), queries, power information, applications, services, threshold values (e.g., defined threshold data throughput values, defined threshold screen timer values, or other type of threshold value), metadata, parameters, traffic flows, policies, defined resource management criteria, resource management algorithms (e.g., resource management algorithms, AI or machine learning algorithms, or other type of algorithm), protocols, interfaces, tools, and/or other information, to facilitate operation of the RMC 600, as more fully disclosed herein, and control data flow between the RMC 600 and other components (e.g., communication devices, applications or application-related devices, a base station or other network component or device of the communication network, data sources, services, or other component or device) associated with the RMC 600.

The data store 616 can store data structures (e.g., user data, metadata), code structure(s) (e.g., modules, objects, hashes, classes, procedures) or instructions, information relating to communication devices, users, subscriber-related information, usage data, historical usage data, location data (e.g., data regarding locations of communication devices), queries, power information, applications, services, threshold values (e.g., defined threshold data throughput values, defined threshold screen timer values, or other type of threshold value), metadata, parameters, traffic flows, policies, defined resource management criteria, resource management algorithms (e.g., resource management algorithms, AI or machine learning algorithms, or other type of algorithm), protocols, interfaces, tools, and/or other information, to facilitate controlling operations associated with the RMC 600. In an aspect, the processor component 614 can be functionally coupled (e.g., through a memory bus) to the data store 616 in order to store and retrieve information desired to operate and/or confer functionality, at least in part, to the communicator component 602, operations manager component 604, monitor component 606, resource adapter component 608, threshold adapter component 610, AI component 612, and/or data store 616, or other component, and/or substantially any other operational aspects of the RMC 600.

Described herein are systems, methods, articles of manufacture, and other embodiments or implementations that can facilitate estimating locations of cells and validating cell locations (e.g., estimated cell locations and/or recorded cell locations from data sources) of cells of a communication network, as more fully described herein. The estimating locations of cells and validating cell locations of cells of a communication network, and/or other features of the disclosed subject matter, can be implemented in connection with any type of device with a connection to, or attempting to connect to, the communication network (e.g., a wireless or mobile device, a computer, a handheld device, or other type of device), any IoT device (e.g., health monitoring device, toaster, coffee maker, blinds, music players, speakers, or other type of IoT device), and/or any connected vehicles (e.g., cars, airplanes, space rockets, and/or other at least partially automated vehicles (e.g., drones)). In some embodiments, the non-limiting term user equipment (UE) is used. It can refer to any type of wireless device that communicates with a radio network node in a cellular or mobile communication system. Examples of UE can be a target device, device to device (D2D) UE, machine type UE or UE capable of machine to machine (M2M) communication, PDA, Tablet, mobile terminals, smart phone, Laptop Embedded Equipped (LEE), laptop mounted equipment (LME), USB dongles, or other type of UE. Note that the terms element, elements and antenna ports can be interchangeably used but carry the same meaning in this disclosure. The embodiments are applicable to single carrier as well as to Multi-Carrier (MC) or Carrier Aggregation (CA) operation of the UE. The term Carrier Aggregation (CA) is also called (e.g., interchangeably called) “multi-carrier system,” “multi-cell operation,” “multi-carrier operation,” “multi-carrier” transmission and/or reception.

In some embodiments, the non-limiting term radio network node or simply network node is used. It can refer to any type of network node that serves one or more UEs and/or that is coupled to other network nodes or network elements or any radio node from where the one or more UEs receive a signal. Examples of radio network nodes are Node B, Base Station (BS), Multi-Standard Radio (MSR) node such as MSR BS, eNode B, network controller, Radio Network Controller (RNC), Base Station Controller (BSC), relay, donor node controlling relay, Base Transceiver Station (BTS), Access Point (AP), transmission points, transmission nodes, RRU, RRH, nodes in Distributed Antenna System (DAS), or other type of radio network node.

Cloud Radio Access Networks (RAN) can enable the implementation of concepts such as software-defined network (SDN) and network function virtualization (NFV) in 5G networks. This disclosure can facilitate a generic channel state information framework design for a 5G network. Certain embodiments of this disclosure can comprise an SDN controller component that can control routing of traffic within the network and between the network and traffic destinations. The SDN controller component can be merged with the 5G network architecture to enable service deliveries via open Application Programming Interfaces (APIs) and move the network core towards an all Internet Protocol (IP), cloud based, and software driven telecommunications network. The SDN controller component can work with, or take the place of Policy and Charging Rules Function (PCRF) network elements so that policies such as quality of service and traffic management and routing can be synchronized and managed end to end.

To meet the huge demand for data centric applications, 4G standards can be applied to 5G, also called New Radio (NR) access. 5G networks can comprise the following: data rates of several tens of megabits per second supported for tens of thousands of users; 1 gigabit per second can be offered simultaneously (or concurrently) to tens of workers on the same office floor; several hundreds of thousands of simultaneous (or concurrent) connections can be supported for massive sensor deployments; spectral efficiency can be enhanced compared to 4G; improved coverage; enhanced signaling efficiency; and reduced latency compared to LTE. In multicarrier system such as OFDM, each subcarrier can occupy bandwidth (e.g., subcarrier spacing). If the carriers use the same bandwidth spacing, then it can be considered a single numerology. However, if the carriers occupy different bandwidth and/or spacing, then it can be considered a multiple numerology.

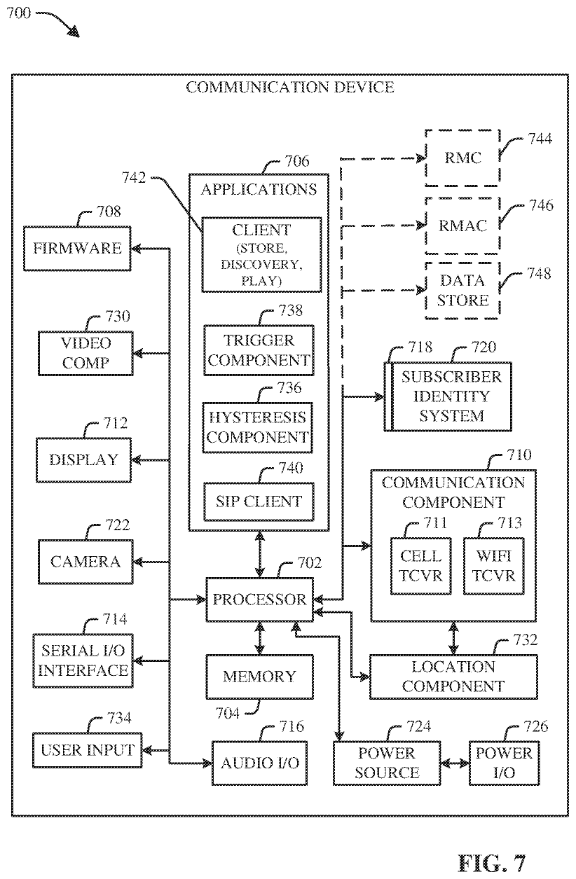

Referring now to FIG. 7, depicted is a block diagram of an example communication device 700 (e.g., UE, wireless or mobile phone, electronic pad or tablet, electronic eyewear, electronic watch, or other electronic bodywear, or IoT device, . . . ) operable to engage in a system architecture that facilitates wireless communications according to one or more embodiments described herein. Although a communication device is illustrated herein, it will be understood that other devices can be a communication device, and that the communication device is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, or other application-related functions or features, that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The communication device 700 can include a processor 702 for controlling and processing all onboard operations and functions. A memory 704 interfaces to the processor 702 for storage of data and one or more applications 706 (e.g., a video player software, user feedback component software, or other type of application). Other applications can include voice recognition of predetermined voice commands that facilitate initiation of the user feedback signals. The applications 706 can be stored in the memory 704 and/or in a firmware 708, and executed by the processor 702 from either or both the memory 704 or/and the firmware 708. The firmware 708 can also store startup code for execution in initializing the communication device 700. A communication component 710 interfaces to the processor 702 to facilitate wired/wireless communication with external systems, e.g., cellular networks, VoIP networks, and so on. Here, the communication component 710 can also include a suitable cellular transceiver 711 (e.g., a GSM transceiver) and/or an unlicensed transceiver 713 (e.g., Wi-Fi, WiMax) for corresponding signal communications. The communication device 700 can be a device such as a cellular telephone, a PDA with mobile communications capabilities, and messaging-centric devices. The communication component 710 also facilitates communications reception from terrestrial radio networks (e.g., broadcast), digital satellite radio networks, and Internet-based radio services networks.

The communication device 700 includes a display 712 for displaying text, images, video, telephony functions (e.g., a Caller ID function), setup functions, and for user input. For example, the display 712 can also be referred to as a “screen” that can accommodate the presentation of multimedia content (e.g., music metadata, messages, wallpaper, graphics, or other type of multimedia content). The display 712 can also display videos and can facilitate the generation, editing and sharing of video quotes. A serial I/O interface 714 is provided in communication with the processor 702 to facilitate wired and/or wireless serial communications (e.g., USB, and/or IEEE 1394) through a hardwire connection, and other serial input devices (e.g., a keyboard, keypad, and mouse). This supports updating and troubleshooting the communication device 700, for example. Audio capabilities are provided with an audio I/O component 716, which can include a speaker for the output of audio signals related to, for example, indication that the user pressed the proper key or key combination to initiate the user feedback signal. The audio I/O component 716 also facilitates the input of audio signals through a microphone to record data and/or telephony voice data, and for inputting voice signals for telephone conversations.

The communication device 700 can include a slot interface 718 for accommodating a SIC (Subscriber Identity Component) in the form factor of a card Subscriber Identity Module (SIM) or universal SIM 720, and interfacing the SIM card 720 with the processor 702. However, it is to be appreciated that the SIM card 720 can be manufactured into the communication device 700, and updated by downloading data and software.

The communication device 700 can process IP data traffic through the communication component 710 to accommodate IP traffic from an IP network such as, for example, the Internet, a corporate intranet, a home network, a person area network, or other type of IP network, through an ISP or broadband cable provider. Thus, VoIP traffic can be utilized by the communication device 700 and IP-based multimedia content can be received in either an encoded or a decoded format.

A video processing component 722 (e.g., a camera) can be provided for decoding encoded multimedia content. The video processing component 722 can aid in facilitating the generation, editing, and sharing of video quotes. The communication device 700 also includes a power source 724 in the form of batteries and/or an AC power subsystem, which power source 724 can interface to an external power system or charging equipment (not shown) by a power I/O component 726.

The communication device 700 can also include a video component 730 for processing video content received and, for recording and transmitting video content. For example, the video component 730 can facilitate the generation, editing and sharing of video quotes. A location tracking component 732 facilitates geographically locating the communication device 700. As described hereinabove, this can occur when the user initiates the feedback signal automatically or manually. A user input component 734 facilitates the user initiating the quality feedback signal. The user input component 734 can also facilitate the generation, editing and sharing of video quotes. The user input component 734 can include such conventional input device technologies such as a keypad, keyboard, mouse, stylus pen, and/or touch screen, for example.

Referring again to the applications 706, a hysteresis component 736 facilitates the analysis and processing of hysteresis data, which can be utilized to determine when to associate with the access point. A software trigger component 738 can be provided that facilitates triggering of the hysteresis component 736 when the Wi-Fi transceiver 713 detects the beacon of the access point. A SIP client 740 enables the communication device 700 to support SIP protocols and register the subscriber with the SIP registrar server. The applications 706 can also include a client 742 that provides at least the capability of discovery, play and store of multimedia content, for example, music.

The communication device 700, as indicated above related to the communication component 710, includes an indoor network radio transceiver 713 (e.g., Wi-Fi transceiver). This function supports the indoor radio link, such as IEEE 802.11, for the dual-mode GSM device (e.g., communication device 700). The communication device 700 can accommodate at least satellite radio services through a device (e.g., handset device) that can combine wireless voice and digital radio chipsets into a single device (e.g., single handheld device).

In some embodiments, the communication device 700 can comprise an RMC 744, an RMAC 746, and/or a data store 748 that can respectively function as more fully described herein. The RMC 744, RMAC 746, and/or data store 748 can be associated with (e.g., communicatively connected to) all or at least a portion of the other components of the communication device 700 to enable the RMC 744, RMAC 746, and/or data store 748 to perform their respective functions.

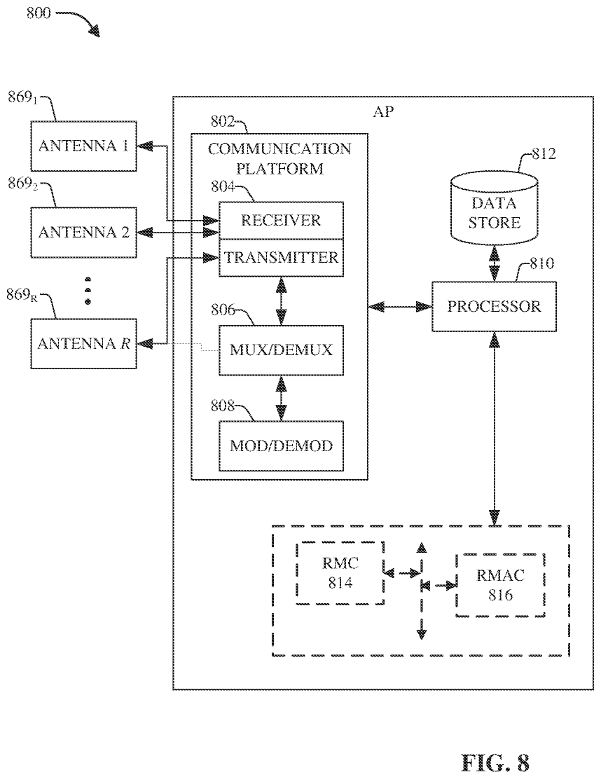

FIG. 8 illustrates a block diagram of an example access point (AP) 800 (e.g., macro base station, femto AP, pico AP, Wi-Fi AP, Wi-Fi-direct AP, or other type of AP), in accordance with various aspects and embodiments of the disclosed subject matter. The AP 800 can receive and transmit signal(s) from and to wireless devices like access points (e.g., base stations, femtocells, picocells, or other type of AP), access terminals (e.g., UEs), wireless ports and routers, and the like, through a set of antennas 869₁-869_{R}. In an aspect, the antennas 869₁-869_{R} are a part of a communication platform 802, which comprises electronic components and associated circuitry that can provide for processing and manipulation of received signal(s) and signal(s) to be transmitted. In an aspect, the communication platform 802 can include a receiver/transmitter 804 that can convert signal from analog to digital upon reception, and from digital to analog upon transmission. In addition, receiver/transmitter 804 can divide a single data stream into multiple, parallel data streams, or perform the reciprocal operation.

In an aspect, coupled to receiver/transmitter 804 can be a multiplexer/demultiplexer (mux/demux) 806 that can facilitate manipulation of signal in time and frequency space. The mux/demux 806 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), or another desired multiplexing scheme. In addition, mux/demux component 806 can scramble and spread information (e.g., codes) according to substantially any code known in the art, e.g., Hadamard-Walsh codes, Baker codes, Kasami codes, polyphase codes, and so on. A modulator/demodulator (mod/demod) 808 also can be part of the communication platform 802, and can modulate information according to multiple modulation techniques, such as frequency modulation, amplitude modulation (e.g., M-ary quadrature amplitude modulation (QAM), with M a positive integer), phase-shift keying (PSK), and the like.

The AP 800 also can comprise a processor(s) 810 that can be configured to confer and/or facilitate providing functionality, at least partially, to substantially any electronic component in or associated with the AP 800. For instance, the processor(s) 810 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, or other operations on data.

In another aspect, the AP 800 can include a data store 812 that can store data structures; code instructions; rate coding information; information relating to measurement of radio link quality or reception of information related thereto; information relating to communication conditions (e.g., signal-to-interference-plus-noise ratio (SINR), reference signal received power (RSRP), reference signal received quality (RSRQ), channel quality indicator (CQI), and/or other wireless communications metrics or parameters) associated with communication devices; information relating to communication devices, users, subscriber-related information, usage data, historical usage data, location data (e.g., data regarding locations of communication devices), queries, power information, applications, services, threshold values (e.g., defined threshold data throughput values, defined threshold screen timer values, or other type of threshold value), metadata, parameters, traffic flows, policies, rules, signaling, defined resource management criteria, resource management algorithms (e.g., resource management algorithms, AI or machine learning algorithms, or other type of algorithm), protocols, interfaces, tools, and/or other information; white list information, information relating to managing or maintaining the white list; system or device information like policies and specifications; code sequences for scrambling; spreading and pilot transmission; floor plan configuration; access point deployment and frequency plans; scheduling policies; and so on. The processor(s) 810 can be coupled to the data store 812 in order to store and retrieve information (e.g., information, such as algorithms, relating to multiplexing/demultiplexing or modulation/demodulation; information relating to radio link levels; information relating to communication conditions (e.g., SINR, RSRP, RSRQ, CQI, and/or other wireless communications metrics or parameters) associated with communication devices; information relating to communication devices, users, subscriber-related information, usage data, historical usage data, location data (e.g., data regarding locations of communication devices), queries, power information, applications, services, threshold values (e.g., defined threshold data throughput values, defined threshold screen timer values, or other type of threshold value), metadata, parameters, traffic flows, policies, rules, signaling, defined resource management criteria, resource management algorithms (e.g., resource management algorithms, AI or machine learning algorithms, or other type of algorithm), protocols, interfaces, tools, and/or other information that can be desired to operate and/or confer functionality to the communication platform 802 and/or other operational components of AP 800.

In some embodiments, the AP 800 can comprise an RMC 814 or an RMAC 816 that can respectively function as more fully described herein. The RMC 814 can be the same as or similar to, and/or can comprise the same or similar functionality as, the RMC, as elsewhere described, and as more fully described, herein. The RMAC 816 can be the same as or similar to, and/or can comprise the same or similar functionality as, the RMAC, as elsewhere described, and as more fully described, herein. The RMC 814 or RMAC 816 can be associated with (e.g., communicatively connected to) all or at least a portion of the other components of the AP 800 to enable the RMC 814 or RMAC 816 to perform their respective functions, as more fully described herein.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

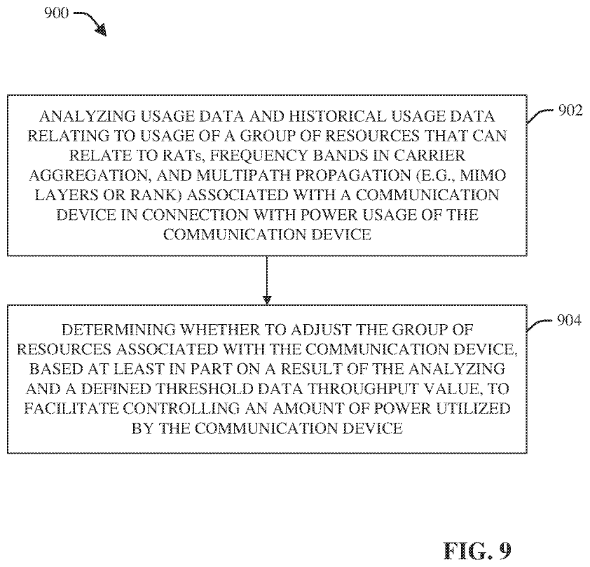

In view of the example systems and/or devices described herein, example methods that can be implemented in accordance with the disclosed subject matter can be further appreciated with reference to flowcharts in FIGS. 9-11. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 9 illustrates a flow chart of an example method 900 that can desirably manage device capabilities, including resources of communication devices, in a utilization-aware manner, in accordance with various aspects and embodiments of the disclosed subject matter. The method 900 can be employed by, for example, a system that can comprise the RMC, RMAC, a processor component (e.g., of or associated with the RMC), and/or a data store (e.g., of or associated with the RMC).

At 902, usage data and historical usage data relating to usage of a group of resources that can relate to RATs, frequency bands in carrier aggregation, and multipath propagation (e.g., MIMO layers or rank) associated with a communication device in connection with power usage of the communication device can be analyzed. The RMC can analyze the usage data and the historical usage data relating to usage of the group of resources that can relate to RATs (e.g., 3G, 4G, LTE, 5G, xG, or other type of RAT), frequency bands in carrier aggregation, and multipath propagation (e.g., MIMO layers or rank) associated with the communication device in connection with power usage of the communication device, as more fully described herein.

At 904, a determination can be made regarding whether to adjust the group of resources associated with the communication device, based at least in part on a result of the analyzing and a defined threshold data throughput value, to facilitate controlling an amount of power utilized by the communication device. The RMC or RMAC can determine whether to adjust the group of resources associated with the communication device, based at least in part on the result of the analyzing and the defined threshold data throughput value, to facilitate controlling an amount of power utilized by the communication device, as more fully described herein. The defined threshold data throughput value can relate to, for example, an amount of data throughput being used, or expected (e.g., predicted or projected) to be used, by the communication device and/or application being utilized or expected to be utilized by the communication device.

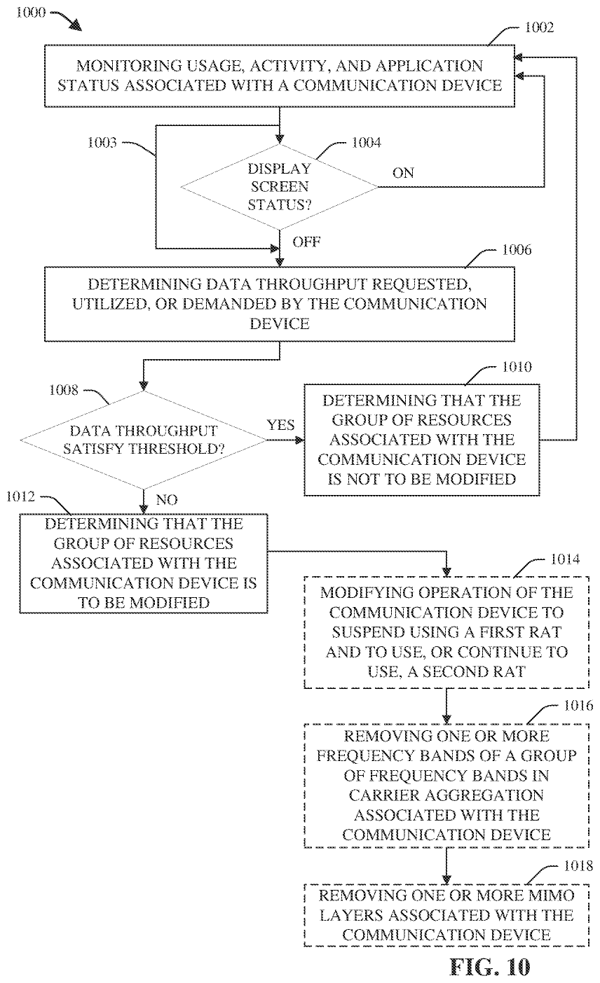

FIG. 10 depicts a flow chart of another example method 1000 that can desirably manage device capabilities, including resources of communication devices, in a utilization-aware manner, in accordance with various aspects and embodiments of the disclosed subject matter. The method 1000 can be employed by, for example, a system that can comprise the RMC, RMAC, a processor component (e.g., of or associated with the RMC), and/or a data store (e.g., of or associated with the RMC).

At 1002, usage, activity, and application status associated with a communication device can be monitored. The RMC or RMAC can monitor the usage, activity, and application status associated with the communication device, including monitoring whether one or more applications are being utilized by the communication device, what type of application(s), if any, is being used, the type of data being communicated, the data throughput associated with the application, if any, the amount of data being communicated (e.g., received or transmitted) in connection with the communication device, and/or the display screen status of the communication device.

At 1004, a determination can be made regarding the status of the display screen of the communication device. In some embodiments, the RMC or RMAC can determine the status (e.g., on or active state, off or sleep state, or other state) of the display screen of the communication device based at least in part on the monitoring of the usage and activity of the communication device.

In response to determining that the display screen is in an on or active state, the method 1000 can return to reference numeral 1002, wherein the usage and activity of the communication device can continue to be monitored. In some embodiments, if the RMC or RMAC determines that the display screen is in an on or active state, the RMC or RMAC can continue to monitor the usage and activity of the communication device.

If, instead, at reference numeral 1004, it is determined that the status of the display screen is an off or inactive state, at 1006, data throughput requested, utilized, or demanded by the communication device can be determined. If the RMC or RMAC determines that the status of the display screen is the off or inactive (e.g., sleep) state, the RMC or RMAC can determine the data throughput requested, utilized, or demanded by the communication device, for example, with regard to an application, based at least in part on an analysis of the usage and activity of the communication device.

It is to be appreciated and understood that, in certain embodiments, as indicated at reference numeral 1003, the method 1000 can perform the other operations of the method 1000, or make determinations regarding to perform the other operations of the method 1000, without regard to the status of the display screen of the communication device, as more fully described herein. That is, in such certain embodiments, the method 1000 can perform other operations of the method 1000 whether the status of the display screen is on or active, or whether the status of the display screen is off or inactive (e.g., is in sleep or reduced power mode). For instance, from reference numeral 1002, the method 1000 (and the RMC or RMAC) can proceed to reference numeral 1003, which can proceed to reference numeral 1006 (e.g., bypassing reference numeral 1004), wherein, at reference numeral 1006, the method 1000 (and the RMC or RMAC) can determine the data throughput requested, utilized, or demanded by the communication device, and/or the method 1000 (and the RMC or RMAC) can perform other operations of the method 1000, without regard to whether the display screen is in an on state or off state (or active state or inactive state).

At 1008, a determination can be made regarding whether the data throughput associated with the communication device satisfies a defined threshold data throughput value. The RMC or RMAC can determine whether the data throughput associated with the communication device satisfies (e.g., meets, breaches, or exceeds) the defined threshold data throughput value based at least in part on the results of analyzing the data throughput requested, utilized, or demanded by the communication device and the defined threshold data throughput value associated with (e.g., applicable to) the communication device. The RMC can determine or adapt the defined threshold data throughput value, as more fully described herein.

If it is determined that the data throughput associated with the communication device satisfies the defined threshold data throughput value, at 1010, a determination can be made that the group of resources associated with the communication device is not to be modified. The group of resources can relate to, for example, RATs, frequency bands in carrier aggregation, multipath propagation (e.g., MIMO layers), and/or other resources associated with the communication device. In response to the RMC or RMAC determining that the data throughput associated with the communication device satisfies the defined threshold data throughput value, the RMC or RMAC can determine that the group of resources associated with the communication device is not to be, or does not have to be, modified. At this point, the method 1000 can return to reference numeral 1002, wherein the usage and activity of the communication device can continue to be monitored (e.g., by the RMC or RMAC).

If, instead, at reference numeral 1008, it is determined that the data throughput associated with the communication device does not satisfy the defined threshold data throughput value, at 1012, a determination can be made that one or more resources of the group of resources can be modified. In response to the RMC or RMAC determining that the data throughput associated with the communication device does not satisfy the defined threshold data throughput value (e.g., the data throughput does not meet or exceed the defined threshold data throughput value), the RMC or RMAC can determine that one or more resources of the group of resources can be or is to be modified.

In some embodiments, in response to determining that one or more resources of the group of resources can be modified, at 1014, operation of the communication device can be modified to suspend using a first RAT and to use, or continue to use, a second RAT. In response to determining that one or more resources of the group of resources can be modified, the RMC or RMAC can modify or facilitate modifying the operation of the communication device to suspend using the first RAT (e.g., 5G) and to use, or continue to use, a second RAT (e.g., LTE), as more fully described herein. For example, the RMC or RMAC can modify or facilitate modifying the operation of the communication device to release the use of 5G (e.g., non-standalone 5G) and to continue the use of LTE (e.g., to fallback to LTE) by the communication device. Modifying the resources to have the communication device fall back from using (e.g., to suspend the use of) the first RAT (e.g., 5G) to using, or maintaining the usage of, the second RAT (e.g., LTE) can desirably reduce the amount of power consumed by the communication device.

In certain embodiments, additionally or alternatively, in response to determining that one or more resources of the group of resources can be modified, at 1016, the group of resources associated with the communication device can be modified to remove one or more frequency bands of a group of frequency bands in carrier aggregation associated with the communication device. In response to determining that one or more resources of the group of resources can be modified, and in addition to or as an alternative to modifying the RAT used by the communication device, the RMC or RMAC can modify the group of resources associated with the communication device to remove one or more frequency bands of the group of frequency bands in carrier aggregation associated with the communication device, as more fully described herein. Modifying the resources to remove one or more frequency bands associated with the communication device can desirably reduce the amount of power consumed by the communication device.

In some embodiments, additionally or alternatively, in response to determining that one or more resources of the group of resources can be modified, at 1018, the group of resources associated with the communication device can be modified to remove one or more MIMO layers associated with the communication device. In response to determining that one or more resources of the group of resources can be modified, and in addition to or as an alternative to modifying the RAT used by the communication device and/or removing one or more frequency bands associated with the communication device, the RMC or RMAC can modify the group of resources associated with the communication device to remove one or more MIMO layers associated with the communication device, as more fully described herein. Modifying the resources to remove one or more MIMO layers associated with the communication device can desirably reduce the amount of power consumed by the communication device.

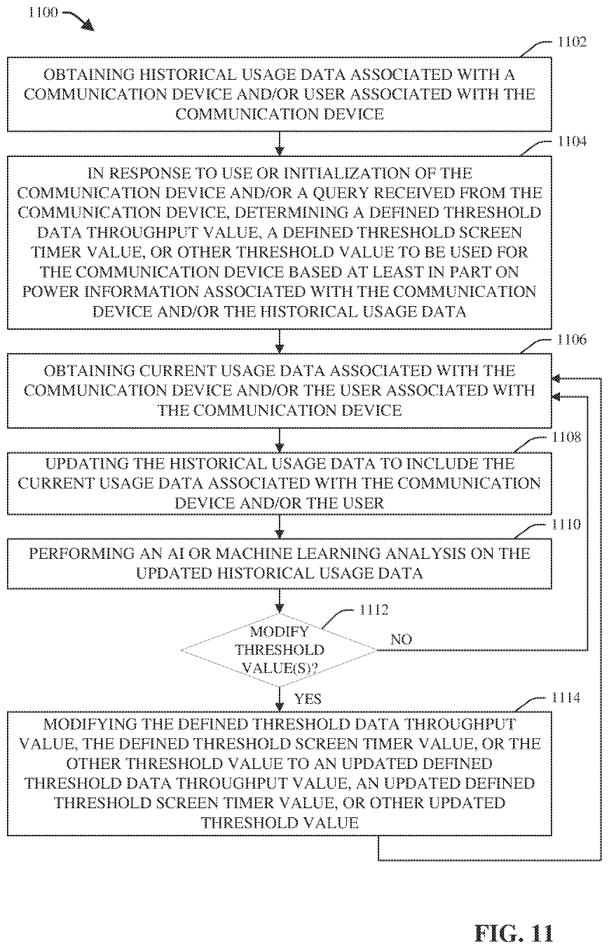

FIG. 11 illustrates a flow chart of another example method 1100 that can perform an AI or machine learning analysis to desirably determine or adapt a defined threshold data throughput to utilize for a communication device to facilitate managing device capabilities, including resources of the communication device, in a utilization-aware manner, in accordance with various aspects and embodiments of the disclosed subject matter. The method 1100 can be employed by, for example, a system that can comprise the RMC, a processor component (e.g., of or associated with the RMC), and/or a data store (e.g., of or associated with the RMC). In some embodiments, the RMC can comprise or be associated with an AI component that can perform an AI or machine learning analysis on data to facilitate determining or adapting a defined threshold data throughput value, defined screen timer value, or other threshold value to utilize for a communication device to facilitate managing device capabilities, including resources of the communication device, in a utilization-aware manner.

At 1102, historical usage data associated with a communication device and/or user associated with the communication device can be obtained. The resource management component can obtain, receive, or collect usage data associated with the communication device and/or the user over time, wherein the usage data can relate to usage (e.g., consumption) of power, usage of resources, usage or statuses of applications or functions, location of the communication device during usage of the communication device, time of use of the communication device, user characteristics of the user (e.g., particular characteristics or demographic characteristics of the user) using the communication device, and/or other usage by or associated with the communication device and/or the user. Such usage data obtained, received, or collected over time can be historical usage data, and the RMC can store the historical usage data in the data store.

At 1104, in response to use or initialization of the communication device and/or a query received from the communication device, a defined threshold data throughput value, a defined threshold screen timer value, or other threshold value to be used for the communication device can be determined based at least in part on power information associated with the communication device and/or the historical usage data. In response to the use or initialization of the communication device by the user (e.g., turning on the communication device, connecting the communication device to the communication network, and/or using the communication device) and/or the query received from the communication device, the RMC can determine the defined threshold data throughput value, the defined threshold screen timer value, and/or other threshold value to be used (e.g., initially used) for the communication device based at least in part on the power information associated with the communication device and/or the historical usage data associated with the communication device and/or the user. For instance, from previous analysis of the historical usage data (e.g., by the AI component), respective defined threshold data throughput values, respective defined threshold screen timer values, or other respective threshold values applicable to respective power information, respective applications or application statuses, respective users, and/or respective contexts can be determined and stored in the data store. The RMC can receive the power information associated with the communication device from the communication network. The RMC can analyze the power information, other currently available information (e.g., currently available usage data) associated with the communication device and/or the user, and/or the historical usage data, comprising the respective defined threshold data throughput values, the respective defined threshold screen timer values, and/or other respective threshold values. Based at least in part on the results of such analysis, the RMC can determine the defined threshold data throughput value, the defined threshold screen timer value, and/or the other threshold value to be used (e.g., initially used) for the communication device.

At 1106, current usage data associated with the communication device and/or the user associated with the communication device can be obtained. The RMC can monitor operation (if any) of the communication device. As the user is using or preparing to use the communication device, the RMC can obtain, receive, or collect the current usage data associated with the communication device and/or the user, wherein the current usage data can relate to current power usage, current resource usage, current usage or status of applications or functions, current location of the communication device during usage of the communication device, current time of use of the communication device, user characteristics of the current user using the communication device, and/or other current usage by or associated with the communication device and/or the user. The RMC can store the current usage data in the data store. The RMC can continue (e.g., on a continuous, substantially continuous, periodic, or dynamic basis) to obtain, receive, or collect current usage data associated with the communication device and/or the user as the communication device continues to operate (e.g., continues to be used by the user).

At 1108, the historical usage data can be updated to include the current usage data associated with the communication device and/or the user. The RMC can update the historical usage data in the data store based at least in part on the current usage data. For instance, the RMC can update the historical usage data to include, reflect, or account for the current usage data.

At 1110, an AI or machine learning analysis can be performed on the updated historical usage data. The AI component can perform an AI or machine learning analysis on the updated historical usage data, which can include the current usage data. The AI component, using the AI or machine learning analysis, can determine or learn, and can continue to determine or learn over time, improvements (e.g., enhancements) that can be made to defined threshold data throughput values, defined threshold screen timer values, or other threshold values to facilitate providing desirable (e.g., improved, suitable, acceptable, or optimal) use and QoE of use of the communication device by the user (or other users), while also desirably (e.g., suitably, acceptably, or optimally) reducing or minimizing the amount of power consumed by the communication device, such as more fully described herein.

At 1112, a determination can be made regarding whether the defined threshold data throughput value, the defined threshold screen timer value, or other threshold value is to be modified, based at least in part on the results of the AI or machine learning analysis. The RMC or AI component can determine whether the defined threshold data throughput value, the defined threshold screen timer value, or other threshold value is to be modified (e.g., adapted), based at least in part on the results of the AI or machine learning analysis. For instance, based at least in part on the results of the AI or machine learning analysis, the AI component can determine, predict, or infer whether a modification to the defined threshold data throughput value, the defined threshold screen timer value, or other threshold value can enhance, or at least can be expected or predicted to enhance, operation of the communication device to desirably reduce or minimize the amount of power consumed by the communication device while also providing desirable use and QoE of use of the communication device by the user (or other users). In some embodiments, if the AI component determines, predicts, or infers that a modification to the defined threshold data throughput value, the defined threshold screen timer value, or other threshold value can enhance, or at least can be expected or predicted to enhance, such operation of the communication device, the AI component can generate a modification recommendation comprising modification information relating to (e.g., indicating or specifying) the modification to the defined threshold data throughput value, the defined threshold screen timer value, or the other threshold value.

The RMC can receive the results of the AI or machine learning analysis from the AI component. The RMC can determine whether the defined threshold data throughput value, the defined threshold screen timer value, or the other threshold value is to be modified, based at least in part on such analysis results. The analysis results can comprise the raw AI or machine learning analysis results, can comprise a recommendation that no modification be made if the AI component determines that no modification is to be made or recommended, and/or can comprise a modification recommendation comprising modification information relating to the modification if the AI component determines that a modification is to be made or recommended.

If, at reference numeral 1112, it is determined that no modification is to be made to the defined threshold data throughput value, the defined threshold screen timer value, or the other threshold value, the method 1100 can return to reference numeral 1106, wherein the method 1100 can proceed from that point to obtain more (e.g., subsequent or updated) current usage data associated with the communication device and/or the user. If the RMC determines that no modification is to be made to the defined threshold data throughput value, the defined threshold screen timer value, the other threshold value, the RMC can continue to monitor operation of the communication device and can obtain more current usage data associated with the communication device and/or the user.

If, instead, at reference numeral 1112, it is determined that a modification is to be made to the defined threshold data throughput value, the defined threshold screen timer value, or the other threshold value, at 1114, the defined threshold data throughput value, the defined threshold screen timer value, or the other threshold value can be modified to an updated (e.g., adapted) defined threshold data throughput value, an updated defined threshold screen timer value, or other updated threshold value. If the RMC determines that a modification is to be made to the defined threshold data throughput value, the defined threshold screen timer value, or the other threshold value, the RMC can modify or facilitate modifying the defined threshold data throughput value to the updated defined threshold data throughput value, modify or facilitate modifying the defined threshold screen timer value to the updated defined threshold screen timer value, or modify or facilitate modifying the other threshold value to the other updated threshold value. For instance, if the RMC is part of the communication device, the RMC can modify the defined threshold data throughput value, the defined threshold screen timer value, or the other threshold value, as appropriate. If the RMC is part of the communication network and/or is in the cloud, or is otherwise external to the communication device, the RMC can communicate modification information relating to the modification to RMAC or the communication device to facilitate modifying the defined threshold data throughput value, the defined threshold screen timer value, or the other threshold value, and the communication device can modify the defined threshold data throughput value, the defined threshold screen timer value, or the other threshold data based at least in part on the modification information.

At this point, the method 1100 can return to reference numeral 1106, wherein the method 1100 can proceed from that point to obtain more (e.g., subsequent or updated) current usage data associated with the communication device and/or the user. After the modification is performed, the RMC or RMAC can continue to monitor operation of the communication device and can obtain more current usage data associated with the communication device and/or the user.

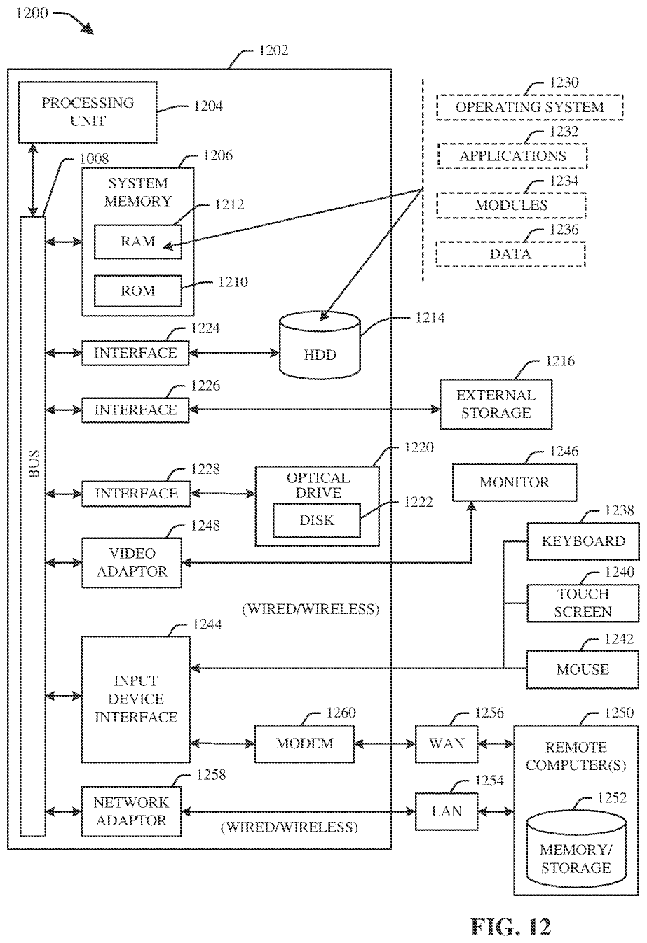

In order to provide additional context for various embodiments described herein, FIG. 12 and the following discussion are intended to provide a brief, general description of a suitable computing environment 1200 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, or other type of program modules, that can perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, or other type of external storage device) and an optical disk drive 1220 (e.g., which can read or write from a CD-ROM disc, a DVD, a BD, or other type of optical disk drive). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enable with a security module, such as a trusted processing module (TPM). For instance with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH™ interface, or other type of interface.

A monitor 1246 or other type of display device can be also connected to the system bus 1208 via an interface, such as a video adapter 1248. In addition to the monitor 1246, a computer typically includes other peripheral output devices (not shown), such as speakers, printers, or other type of peripheral output device.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256, e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, or other type of wirelessly detectable tag), and telephone. This can include Wireless Fidelity (Wi-Fi) and BLUETOOTH™ wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, or other version of IEEE 802.11) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

It is to be noted that aspects, features, and/or advantages of the disclosed subject matter can be exploited in substantially any wireless telecommunication or radio technology, e.g., Wi-Fi; Gi-Fi; Hi-Fi; BLUETOOTH™; worldwide interoperability for microwave access (WiMAX); enhanced general packet radio service (enhanced GPRS); third generation partnership project (3GPP) long term evolution (LTE); third generation partnership project 2 (3GPP2) ultra mobile broadband (UMB); 3GPP universal mobile telecommunication system (UMTS); high speed packet access (HSPA); high speed downlink packet access (HSDPA); high speed uplink packet access (HSUPA); GSM (global system for mobile communications) EDGE (enhanced data rates for GSM evolution) radio access network (GERAN); UMTS terrestrial radio access network (UTRAN); LTE advanced (LTE-A); or other type of wireless telecommunication or radio technology. Additionally, some or all of the aspects described herein can be exploited in legacy telecommunication technologies, e.g., GSM. In addition, mobile as well non-mobile networks (e.g., the internet, data service network such as internet protocol television (IPTV), or other type of non-mobile network) can exploit aspects or features described herein.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, or other type of magnetic storage device), optical discs (e.g., compact disc (CD), digital versatile disc (DVD), blu-ray disc (BD), or other type of optical disc), smart cards, and memory devices comprising volatile memory and/or non-volatile memory (e.g., flash memory devices, such as, for example, card, stick, key drive, or other type of volatile memory and/or non-volatile memory), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field PGA (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component”, “system”, “platform”, “framework”, “layer”, “interface”, “agent”, and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment” (UE), “mobile station,” “mobile,” “wireless device,” “wireless communication device,” “subscriber station,” “subscriber equipment,” “access terminal,” “terminal,” “handset,” and similar terminology are used herein to refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point” (AP), “base station,” “node B,” “evolved node B” (eNode B or eNB), “home node B” (HNB), “home access point” (HAP), and the like are utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “subscriber,” “customer,” “consumer,” “owner,” “agent,” and the like are employed interchangeably throughout the subject specification, unless context warrants particular distinction(s) among the terms. It should be appreciated that such terms can refer to human entities or automated components supported through artificial intelligence (e.g., a capacity to make inference based on complex mathematical formalisms), which can provide simulated vision, sound recognition and so forth.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., communication device, communication network, base station, application component, authorization component, service, processor component, data store, . . . ), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
analyzing, by a system comprising a processor, usage data and historical usage data relating to usage of a group of resources that relate to radio access technologies, frequency bands in carrier aggregation, and multipath propagation associated with a device in connection with power usage of the device; and
determining, by the system, whether to adjust the group of resources associated with the device, based on a result of the analyzing and a defined threshold data throughput value, to facilitate controlling an amount of power utilized by the device.

2. The method of claim 1, further comprising:
determining, by the system, that a display screen of the device is in an off state, based on the result of the analyzing, wherein the determining whether to adjust the group of resources associated with the device comprises determining whether to adjust the group of resources associated with the device based on the result of the analyzing, the defined threshold data throughput value, and the display screen being determined to be in the off state.

3. The method of claim 1, further comprising:
based on the result of the analyzing, determining, by the system, that data throughput associated with the device does not satisfy the defined threshold data throughput value relating to the data throughput; and
based on the data throughput being determined to not satisfy the defined threshold data throughput value, determining, by the system, that the group of resources is to be adjusted.

4. The method of claim 3, further comprising:
in response to determining that the group of resources is to be adjusted, removing, by the system, a frequency band of the frequency bands that is associated with the device, to facilitate reducing the amount of power utilized by the device.

5. The method of claim 3, wherein the multipath propagation relates to multiple-input, multiple-output layers associated with the device, and wherein the method further comprises:
in response to determining that the group of resources is to be adjusted, reducing, by the system, a number of the multiple-input, multiple-output layers associated with the device, to facilitate reducing the amount of power utilized by the device.

6. The method of claim 3, wherein the radio access technologies comprises a radio access technology associated with the device and a legacy radio access technology associated with the device, wherein the legacy radio access technology is an older radio access technology than the radio access technology, and wherein the method further comprises:
in response to determining that the group of resources is to be adjusted,
suspending, by the system, utilization of the radio access technology; and
utilizing, by the system, the legacy radio access technology, to facilitate reducing the amount of power utilized by the device.

7. The method of claim 6, wherein the legacy radio access technology is a fourth generation long-term-evolution radio access technology, wherein the radio access technology is a fifth generation radio access technology that employs a non-standalone technology that utilizes the fourth generation long-term-evolution radio access technology as an anchor to carry signaling associated with the device, wherein the suspending of the utilization of the radio access technology comprises suspending the utilization of the fifth generation radio access technology, and wherein the utilizing of the legacy radio access technology comprises utilizing the fourth generation long-term-evolution radio access technology.

8. The method of claim 1, further comprising:
based on the result of the analyzing, determining, by the system, that data throughput associated with the device satisfies the defined threshold data throughput value relating to the data throughput; and
based on the data throughput being determined to satisfy the defined threshold data throughput value, determining, by the system, that the group of resources is not to be adjusted.

9. The method of claim 1, wherein the analyzing comprises performing, by the system, an artificial intelligence analysis on application statuses of applications associated with the device, the usage data and the historical usage data relating to the usage of the group of resources, and wherein the method further comprises:
determining, by the system, the defined threshold data throughput value or a defined threshold time for turning a display screen of the device from an on state to an off state, based on an artificial intelligence analysis result of the performing of the artificial intelligence analysis.

10. The method of claim 9, wherein the artificial intelligence analysis result is a first artificial intelligence analysis result, and wherein the method further comprises:
receiving, by the system, an application status of an application utilized by the device and updated usage data relating to the usage of the group of resources associated with the device, wherein the performing of the artificial intelligence analysis comprises performing an updated artificial intelligence analysis on the application status, the updated usage data, historical application statuses of the applications, the usage data, and the historical usage data; and
determining, by the system, whether to adjust the defined threshold data throughput value or the defined threshold time, based on a second artificial intelligence analysis result of the performing of the updated artificial intelligence analysis.

11. The method of claim 10, further comprising:
one of:
adjusting, by the system, the defined threshold data throughput value or the defined threshold time, based on the second artificial intelligence analysis result of the performing of the updated artificial intelligence analysis; or
determining, by the system, that the defined threshold data throughput value and the defined threshold time are not to be adjusted, based on the second artificial intelligence analysis result of the performing of the updated artificial intelligence analysis.

12. The method of claim 1, wherein the device is a first device associated with a first identity, wherein a defined threshold time for turning a display screen from an on state to an off state is associated with the first device, wherein the result is a first result, and wherein the method further comprises:
analyzing, by the system, first characteristics data relating to a first group of characteristics associated with the first device or the first identity, and second characteristics data relating to a second group of characteristics associated with a second device or a second identity;
determining, by the system, that the first group of characteristics and the second group of characteristics satisfy a defined similarity criterion, based on a second result of the analyzing of the first characteristics data and the second characteristics data; and
in response to determining that the first group of characteristics and the second group of characteristics satisfy the defined similarity criterion, propagating, by the system, the defined threshold data throughput value or the defined threshold time from the first device to the second device for use of the defined threshold data throughput value or the defined threshold time with regard to the second device.

13. The method of claim 11, wherein the first group of characteristics comprises first usage activity associated with the first device, a first type of the first device, a first application associated with the first device, a first demographic characteristic associated with the first identity, a first location of the first device, a first event characteristic relating to a first event associated with the first device, or a first account characteristic associated with the first device, and
wherein the second group of characteristics comprises second usage activity associated with the second device, a second type of the second device, a second application associated with the second device, a second demographic characteristic associated with the second identity, a second location of the second device, a second event characteristic relating to the first event or a second event associated with the second device, or a second account characteristic associated with the second device.

14. A system, comprising:
a processor; and
a memory that stores executable instructions that, when executed by the processor, facilitate performance of operations, comprising:
evaluating usage information and historical usage information relating to usage of a group of resources associated with radio access technologies, frequency bands in carrier aggregation, and multipath propagation associated with a device with regarding to power consumption of the device; and
determining whether to modify the group of resources associated with the device, based on a result of the evaluating and a defined threshold data throughput value, to facilitate managing an amount of power consumed by the device.

15. The system of claim 14, wherein the operations further comprise:
determining that a display screen of the device is in an inactive state, based on the result of the evaluating, wherein the determining whether to modify the group of resources associated with the device comprises determining whether to modify the group of resources associated with the device based on the result of the evaluating, the defined threshold data throughput value, and the display screen being determined to be in the inactive state.

16. The system of claim 14, wherein the operations further comprise:
based on the result of the evaluating, determining that data throughput associated with the device is not greater than the defined threshold data throughput value relating to the data throughput; and
based on the data throughput being determined to not be greater than the defined threshold data throughput value, determining that the group of resources is to be modified.

17. The system of claim 16, wherein the multipath propagation relates to multiple-input, multiple-output layers associated with the device, wherein the radio access technologies comprises a first radio access technology and a second radio access technology associated with the device, wherein the first radio access technology originated prior to the second radio access technology, and wherein the operations further comprise:
in response to determining that the group of resources is to be modified, and to facilitate reducing the amount of power consumed by the device:
removing a frequency band of the frequency bands that is associated with the device;
reducing a rank associated with the multiple-input, multiple-output layers associated with the device to reduce a number of the multiple-input, multiple-output layers associated with the device; or
disabling the second radio access technology, and
utilizing the first radio access technology.

18. The system of claim 14, wherein the operations further comprise:
based on the result of the evaluating, determining that data throughput associated with the device is same as or exceeds the defined threshold data throughput value relating to the data throughput; and
based on the data throughput being determined to be the same as or exceed the defined threshold data throughput value, determining that the group of resources is not to be modified.

19. A non-transitory machine-readable medium, comprising executable instructions that, when executed by a processor, facilitate performance of operations, comprising:
analyzing usage information and historical usage information relating to usage of a group of resources relating to radio access technologies, frequency bands in carrier aggregation, and multiple-input, multiple-output layers associated with a device in connection with power consumption associated with the device; and
determining whether to change the group of resources associated with the device, based on a result of the analyzing and a defined threshold data throughput value, to facilitate mitigating an amount of power consumed by the device.

20. The non-transitory machine-readable medium of claim 19, wherein the radio access technologies comprise a first radio access technology and a second radio access technology, and wherein the operations further comprise:
based on the result of the analyzing, determining that data throughput associated with the device does not satisfy the defined threshold data throughput value relating to the data throughput; or
based on the data throughput being determined to not satisfy the defined threshold data throughput value, determining that the group of resources is to be changed to:
modify operation of the device to discontinue use of the second radio access technology and use or continue to use the first radio access technology,
remove a frequency band of the frequency bands, or
reduce a number of the multiple-input, multiple-output layers associated with the device.
